(19) United States
(12) Patent Application Publication
(10) Pub. No.: US 2026/0200283 A1
(43) Pub. Date: Jul. 16, 2026

(54) TEMPERATURE ADJUSTMENT DEVICE

(71) Applicant: DENSO CORPORATION, Kariya-city (JP)

(72) Inventors: Motomasa IIZUKA, Nisshin-city (JP); Takanobu AOCHI, Nisshin-city (JP); Tetsuma TAKEDA, Kariya-city (JP)

(21) Appl. No.: 19/558,079

(22) Filed: Mar. 5, 2026

Related U.S. Application Data
(63) Continuation of application No. PCT/JP2024/032728, filed on Sep. 12, 2024.

(30) Foreign Application Priority Data
Sep. 28, 2023 (JP) 2023-168643

(51) Int. Cl. B60H 1/00; H01M 10/613; H01M 10/625; H01M 10/633; H01M 10/6569; H01M 10/663

(52) U.S. Cl. CPC B60H 1/00278; B60H 1/00921; H01M 10/613; H01M 10/625; H01M 10/633; H01M 10/6569; H01M 10/663; B60H 2001/00307; B60H 2001/00928; H01M 2220/20

(57) ABSTRACT

A temperature adjustment device is applied to a vehicle that includes an electric drive unit, a battery and a vehicle air-conditioning device including a refrigeration cycle configured to circulate a refrigerant. The temperature adjustment device includes: a heat medium circuit configured to circulate a heat medium for exchanging heat with at least one of the electric drive unit and the battery; a heat exchange unit that is provided in the heat medium circuit and is configured to exchange heat between the heat medium, which has previously exchanged heat with at least one of the electric drive unit and the battery, and the refrigerant; and a single circuit switching device that is connected to the electric drive unit, the battery and the heat exchange unit and is provided in the heat medium circuit.

### CROSS REFERENCE TO RELATED APPLICATIONS

This application is a continuation application of International Patent Application No. PCT/JP2024/032728 filed on September 12, 2024, which designated the U.S. and claims the benefit of priority from Japanese Patent Application No. 2023-168643 filed on September 28, 2023. The entire disclosures of all of the above applications are incorporated herein by reference.

### TECHNICAL FIELD

The present disclosure relates to a temperature adjustment device.

### BACKGROUND

Previously, there has been proposed a temperature adjustment device that includes: a heat medium circuit, through which a heat medium flows; an electric motor; a battery, which supplies electric power to the electric motor; a chiller, which removes heat from the heat medium; a radiator, which cools the heat medium; and a plurality of switching devices, which switch the heat medium circuit. The heat medium circuit has: a first loop, in which the heat medium passes through the electric motor and the chiller; a second loop, in which the heat medium circulates through the battery; and a third loop, in which the heat medium passes through the electric motor, the chiller and the battery. Furthermore, the heat medium circuit has: a bypass passage, which bypasses the chiller; and a bypass passage, which bypasses the radiator. The temperature adjustment device switches the heat medium circuit, through which the heat medium flows, among the first loop, the second loop and the third loop by a plurality of valves. Furthermore, the temperature adjustment device uses the plurality of valves to switch whether the heat medium passes through the chiller and the radiator.

### SUMMARY

According to the present disclosure, there is provided a temperature adjustment device to be applied to a vehicle that includes an electric drive unit, which is configured to output drive force for driving the vehicle, a battery, which is configured to supply electric power to the electric drive unit, and a vehicle air-conditioning device, which includes a refrigeration cycle that is configured to circulate a refrigerant. The temperature adjustment device may include a heat medium circuit, a heat exchange unit and a single circuit switching device. The heat medium circuit may be configured to circulate a heat medium for exchanging heat with at least one of the electric drive unit and the battery. The heat exchange unit may be provided in the heat medium circuit and may be configured to exchange heat between the heat medium, which has previously exchanged heat with at least one of the electric drive unit and the battery, and the refrigerant. The single circuit switching device may be connected to the electric drive unit, the battery and the heat exchange unit and may be provided in the heat medium circuit. The single circuit switching device may be configured to switch the heat medium circuit so as to selectively form at least one of: a first circuit that may be configured to guide the heat medium, which has previously exchanged heat with the electric drive unit, to the battery; a second circuit that may be configured to guide the heat medium, which has previously exchanged heat with the electric drive unit, to the heat exchange unit; and a third circuit that may be configured to return the heat medium, which has previously exchanged heat with the battery, to the battery while the third circuit bypasses the electric drive unit and the heat exchange unit.

### BRIEF DESCRIPTION OF DRAWINGS

The drawings described herein are for illustrative purposes only of selected embodiments and not all possible implementations, and are not intended to limit the scope of the present disclosure.

FIG. 1 is an overall configuration diagram of a temperature adjustment device according to a first embodiment.

FIG. 2 is a block diagram showing a controller device of the temperature adjustment device according to the first embodiment.

FIG. 3 is a diagram showing flows of a refrigerant and a coolant when the temperature adjustment device of the first embodiment operates in a first mode.

FIG. 4 is a diagram showing flows of the refrigerant and the coolant when the temperature adjustment device of the first embodiment operates in a second mode.

FIG. 5 is a diagram showing flows of the refrigerant and the coolant when the temperature adjustment device of the first embodiment operates in a third mode.

FIG. 6 is a flowchart showing a control process executed by the controller device of the temperature adjustment device according to the first embodiment.

FIG. 7 is a diagram for explaining transfer of heat and a method of utilizing the heat when the temperature adjustment device of the first embodiment operates in the first mode, the second mode and the third mode.

FIG. 8 is an overall configuration diagram of a comparative temperature adjustment device.

FIG. 9 is a diagram for explaining transfer of heat and a method of utilizing the heat when the comparative temperature adjustment device operates in the first mode and the third mode.

FIG. 10 is a diagram for explaining differences in energy consumption between the temperature adjustment device of the first embodiment and the comparative temperature adjustment device.

FIG. 11 is an overall configuration diagram of a temperature adjustment device according to a second embodiment.

FIG. 12 is a diagram showing flows of the refrigerant and the coolant when the temperature adjustment device of the second embodiment operates in the second mode.

FIG. 13 is an overall configuration diagram of a temperature adjustment device according to a third embodiment.

FIG. 14 is a diagram showing the flows of the refrigerant and the coolant when the temperature adjustment device of the third embodiment operates in the second mode.

FIG. 15 is an overall configuration diagram of a temperature adjustment device according to a fourth embodiment.

FIG. 16 is a diagram showing the flows of the refrigerant and the coolant when the temperature adjustment device of the fourth embodiment operates in the first mode.

FIG. 17 is a diagram showing the flows of the refrigerant and the coolant when the temperature adjustment device of the fourth embodiment operates in the second mode.

FIG. 18 is a diagram showing the flows of the refrigerant and the coolant when the temperature adjustment device of the fourth embodiment operates in the third mode.

### DETAILED DESCRIPTION

Previously, there has been proposed a temperature adjustment device that includes: a heat medium circuit, through which a heat medium flows; an electric motor; a battery, which supplies electric power to the electric motor; a chiller, which removes heat from the heat medium; a radiator, which cools the heat medium; and a plurality of switching devices, which switch the heat medium circuit. The heat medium circuit has: a first loop, in which the heat medium passes through the electric motor and the chiller; a second loop, in which the heat medium circulates through the battery; and a third loop, in which the heat medium passes through the electric motor, the chiller and the battery. Furthermore, the heat medium circuit has: a bypass passage, which bypasses the chiller; and a bypass passage, which bypasses the radiator. The temperature adjustment device switches the heat medium circuit, through which the heat medium flows, among the first loop, the second loop and the third loop by a plurality of valves. Furthermore, the temperature adjustment device uses the plurality of valves to switch whether the heat medium passes through the chiller and the radiator.

For example, the temperature adjustment device uses a first switching device, which is one of the plurality of switching devices, to switch between: a first mode, in which the heat medium independently flows through the first loop and the second loop respectively; and a second mode, in which the heat medium flows through the third loop. Furthermore, the temperature adjustment device uses an adjustment valve, which is one of the plurality of switching devices, to open and close the bypass passage that bypasses the chiller in the second mode. Furthermore, the temperature adjustment device uses a third switching device, which is one of the plurality of switching devices, to switch, in each of the first mode and the second mode, whether the heat medium passes through the radiator or not.

In this manner, the temperature adjustment device described above is configured to have the three circuit switching devices that switch the heat medium circuit, thereby switching the heat medium circuit and guiding the heat medium to various components.

Note that in the temperature adjustment device, the greater the number of switching devices that switch the heat medium circuit, the more complex the heat medium circuit becomes. However, the increased complexity of the heat medium circuit leads to factors such as an increase in the size of the housing of the temperature adjustment device and an increase in heat loss when the heat medium flows through the heat medium circuit.

According to one aspect of the present disclosure, there is provided a temperature adjustment device to be applied to a vehicle that includes an electric drive unit, which is configured to output drive force for driving the vehicle, a battery, which is configured to supply electric power to the electric drive unit, and a vehicle air-conditioning device, which includes a refrigeration cycle that is configured to circulate a refrigerant. The temperature adjustment device includes: a heat medium circuit that is configured to circulate a heat medium for exchanging heat with at least one of the electric drive unit and the battery; a heat exchange unit that is provided in the heat medium circuit and is configured to exchange heat between the heat medium, which has previously exchanged heat with at least one of the electric drive unit and the battery, and the refrigerant; and a single circuit switching device that is connected to the electric drive unit, the battery and the heat exchange unit and is provided in the heat medium circuit. The single circuit switching device is configured to switch the heat medium circuit so as to selectively form at least one of: a first circuit that is configured to guide the heat medium, which has previously exchanged heat with the electric drive unit, to the battery; a second circuit that is configured to guide the heat medium, which has previously exchanged heat with the electric drive unit, to the heat exchange unit; and a third circuit that is configured to return the heat medium, which has previously exchanged heat with the battery, to the battery while the third circuit bypasses the electric drive unit and the heat exchange unit.

In this manner, with the configuration in which the single circuit switching device switches the heat medium circuit among the first circuit, the second circuit and the third circuit, the number of circuit switching devices in the temperature adjustment device can be reduced. Therefore, the configuration of the heat medium circuit, through which the heat medium circulates, can be simplified.

Hereinafter, embodiments of the present disclosure will be described with reference to the drawings. In the following embodiments, the same reference signs may be assigned to portions that are the same as or equivalent to those described in the preceding embodiment(s), and the description thereof may be omitted. Furthermore, when only a portion of any one of the components is described in the embodiment, the description of the component described in the preceding embodiment can be applied to the rest of the component. The following embodiments may be partially combined with each other as long as the combination does not cause any trouble, even if not explicitly stated.

### First Embodiment

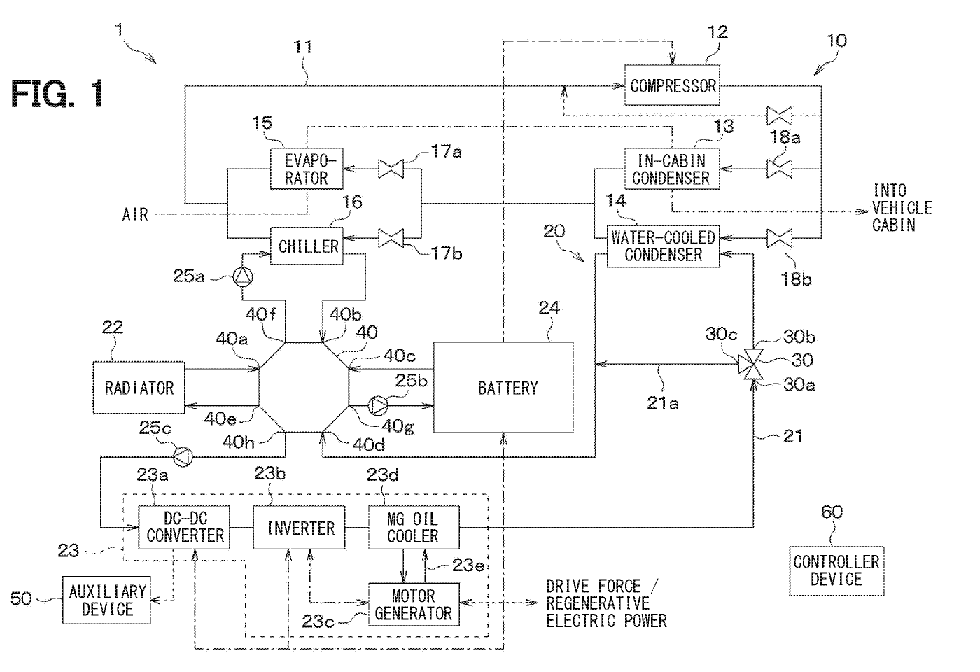

A temperature adjustment device 1 of the present embodiment will be described with reference to FIGS. 1 to 10. In the present embodiment, an example, in which the temperature adjustment device 1 is applied to an electric vehicle (also referred to as an electric automobile), will be described. As shown in FIG. 1, the temperature adjustment device 1 includes, in addition to a refrigeration cycle 10 that circulates a refrigerant as a heat medium, a fluid circuit system 20 that circulates a fluid as a heat medium. The temperature adjustment device 1 is a device that distributes heat, which is generated by the refrigeration cycle 10 and by heat generating devices of the fluid circuit system 20, to various constituent devices, which require heat, via the refrigerant circulating through the refrigeration cycle 10 and the fluid circulating through the fluid circuit system 20. The temperature adjustment device 1 is used to appropriately adjust the temperatures of the refrigerant and the fluid when the heat is distributed to the various constituent devices. The temperature adjustment device 1 switches the flows of the refrigerant circulating through the refrigeration cycle 10 and the fluid circulating through the fluid circuit system 20 according to the operating modes described later.

The refrigeration cycle 10 employs, as the refrigerant, for example, an HFO refrigerant, specifically R1234yf, and is configured as a vapor compression type subcritical refrigeration cycle in which the pressure of the discharged refrigerant from the compressor 12 does not exceed the critical pressure of the refrigerant. Note that, as the refrigerant, either an HFC refrigerant, for example R134a, or a natural refrigerant, for example carbon dioxide, may be used.

In the fluid circuit system 20, as the fluid, for example, a coolant may be employed. Specifically, the coolant may be either a solution containing ethylene glycol, dimethylpolysiloxane, a nanofluid, or the like, or an antifreeze. However, the coolant may be a water-containing liquid other than the antifreeze.

First, the refrigeration cycle 10 will be described. The refrigeration cycle 10 is used in a vehicle air-conditioning device (not shown) installed in the electric vehicle. The vehicle air-conditioning device blows cooled or heated air into a vehicle cabin in order to perform air-conditioning of the vehicle cabin. The refrigeration cycle 10 circulates the refrigerant and has functions of cooling the blown air delivered by the vehicle air-conditioning device and heating the coolant circulating through the fluid circuit system 20.

As shown in FIG. 1, the refrigeration cycle 10 includes a refrigerant circulation passage 11 for circulating the refrigerant. A compressor 12 for compressing the refrigerant, an in-cabin condenser 13 for heat exchange between the refrigerant and the blown air, and a water-cooled condenser 14 for heat exchange between the refrigerant and the coolant circulating through the fluid circuit system 20 are provided in the refrigerant circulation passage 11. In addition, an evaporator 15 for cooling the blown air, a chiller 16 for heat exchange between the refrigerant and the coolant circulating through the fluid circuit system 20, and a first expansion valve 17a and a second expansion valve 17b for reducing the pressure of the refrigerant are provided in the refrigerant circulation passage 11.

The compressor 12 is a compression device that suctions the refrigerant and compresses and discharges the suctioned refrigerant in the refrigeration cycle 10. For example, the compressor 12 is an electric compressor in which an electric motor rotationally drives a fixed-displacement compression mechanism having a fixed discharge capacity. The compressor 12 is electrically connected to a battery 24 described later, and the electric motor is rotationally driven by electric power supplied from the battery 24. Further, the compressor 12 is electrically connected to a controller device (or simply referred to as a controller) 60 described later, and a rotational speed (i.e., a refrigerant discharge capacity) of the compressor 12 is controlled by a control signal outputted from the controller device 60. The in-cabin condenser 13 and the water-cooled condenser 14 are connected to a discharge port of the compressor 12, from which the high-temperature, high-pressure refrigerant is discharged to the in-cabin condenser 13 and the water-cooled condenser 14. In FIG. 1, the flow of electric power supplied from the battery 24 is indicated by a dot-dash-line.

The in-cabin condenser 13 is a heating heat exchanger that heats the blown air by exchanging heat between: the high-temperature, high-pressure refrigerant, which is discharged from the compressor 12; and the blown air, which is cooled and dehumidified by the evaporator 15. The in-cabin condenser 13 is disposed in an air-conditioning case (not shown) of the vehicle air-conditioning device. In FIG. 1, the flow of blown air into the vehicle cabin is indicated by a dot-dot-dash line.

A first valve 18a, which is configured to restrict inflow of the refrigerant into the in-cabin condenser 13, is provided on the inlet side of the in-cabin condenser 13. The inflow of the refrigerant into the in-cabin condenser 13 is controlled by the first valve 18a. The first valve 18a is electrically connected to the controller device 60 and opening and closing of the first valve 18a are controlled by a control signal outputted from the controller device 60.

The water-cooled condenser 14 is a coolant (water)-refrigerant heat exchanger that exchanges heat between: the high-temperature, high-pressure refrigerant, which is discharged from the compressor 12; and the coolant, which is circulated through the fluid circuit system 20, thereby cooling or heating the coolant. The water-cooled condenser 14 has a refrigerant passage, through which the refrigerant discharged from the compressor 12 flows, and a coolant passage, through which the coolant circulating through the fluid circuit system 20 flows. The refrigerant passage of the water-cooled condenser 14 is connected to the refrigeration cycle 10, and the coolant passage of the water-cooled condenser 14 is connected to the fluid circuit system 20.

A second valve 18b, which is configured to restrict inflow of the refrigerant into the water-cooled condenser 14, is provided on the inlet side of the water-cooled condenser 14. The inflow of the refrigerant into the water-cooled condenser 14 is controlled by the second valve 18b. The second valve 18b is electrically connected to the controller device 60, and opening and closing of the second valve 18b are controlled by a control signal outputted from the controller device 60.

Outlets of the in-cabin condenser 13 and the water-cooled condenser 14 are connected to the evaporator 15 via the first expansion valve 17a and are also connected to the chiller 16 via the second expansion valve 17b.

Each of the first expansion valve 17a and the second expansion valve 17b is a pressure reducer that depressurizes the high-pressure refrigerant discharged from the in-cabin condenser 13 and the water-cooled condenser 14 and adjusts the flow rate of the refrigerant conducted to the downstream side thereof, i.e., the mass flow rate. Each of the first expansion valve 17a and the second expansion valve 17b may, for example, employ an electrically operated variable throttling mechanism that includes a valve element, which is configured to change a variable throttle opening degree, and an electric actuator, which is configured to change the opening degree of the valve element.

By changing the valve opening degree of each of the first expansion valve 17a and the second expansion valve 17b over a range from fully closed to fully open, the flow rate of the refrigerant, which flows toward the downstream side of the expansion valve 17a, 17b in the refrigerant circulation passage 11, can be adjusted. The first expansion valve 17a and the second expansion valve 17b are electrically connected to the controller device 60, and the valve opening degree of each of the first expansion valve 17a and the second expansion valve 17b is controlled by a control signal outputted from the controller device 60. The evaporator 15 is connected to an outlet of the first expansion valve 17a. The chiller 16 is connected to an outlet of the second expansion valve 17b.

The evaporator 15 is an evaporation device that exchanges heat between the low-pressure refrigerant depressurized by the first expansion valve 17a and the blown air to be blown into the vehicle cabin to evaporate the low-pressure refrigerant and thereby produce a heat-absorbing effect of the refrigerant so as to cool the blown air. The evaporator 15 is disposed within an air-conditioning case (not shown) of the vehicle air-conditioning device at a location on the upstream side of the in-cabin condenser 13 in the air flow direction. Further, the outlet of the evaporator 15 is connected to the suction inlet of the compressor 12.

Also, an air mix door (not shown) is provided in the air-conditioning case to adjust an air flow rate ratio between the air flow rate of the blown air, which passes through the in-cabin condenser 13, and the air flow rate of the blown air, which bypasses the in-cabin condenser 13, among the blown air after passing through the evaporator 15. This air mix door adjusts the temperature of the conditioned air that flows through the air-conditioning case and is blown into the vehicle cabin.

The chiller 16 can function as an evaporation device that exchanges heat between the low-pressure refrigerant, which is depressurized at the second expansion valve 17b, and the coolant, which is circulated through the fluid circuit system 20, thereby evaporating the low-pressure refrigerant and implementing a heat-absorbing effect on the refrigerant. The chiller 16 can also function as a heater that exchanges heat between the low-pressure refrigerant, which has passed through the second expansion valve 17b, and the coolant, which is circulated through the fluid circuit system 20, thereby heating the low-pressure refrigerant. The chiller 16 cools or heats the coolant in accordance with the operating mode of the temperature adjustment device 1. The chiller 16 includes a refrigerant passage through which the low-pressure refrigerant discharged from the second expansion valve 17b flows, and a coolant passage through which the coolant circulating through the fluid circuit system 20 flows. An outlet of the refrigerant passage of the chiller 16 is connected to the suction inlet of the compressor 12.

Next, the fluid circuit system 20 will be described. As shown in FIG. 1, the fluid circuit system 20 includes a coolant circulation passage 21 which is a heat medium circuit for circulating the coolant. The coolant circulation passage 21 is formed by piping (i.e., a system or network of pipes) through which the coolant circulates. The above-described water-cooled condenser 14 and chiller 16, a radiator 22, which exchanges heat between the coolant circulating through the fluid circuit system 20 and outside air, and an electric drive unit 23, which outputs drive force for driving the electric vehicle, are provided in the coolant circulation passage 21. Furthermore, the coolant circulation passage 21 is provided with: the battery 24, which supplies electric power to the electric drive unit 23; the first pump 25a, the second pump 25b and the third pump 25c, which circulate the coolant; and the three-way valve 30 and the eight-way valve 40, which switch the coolant circulation passage 21.

As described above, the water-cooled condenser 14 is the water–refrigerant heat exchanger that cools or heats the coolant, which circulates through the fluid circuit system 20, by using the high-temperature, high-pressure refrigerant discharged from the compressor 12 of the refrigeration cycle 10. In the water-cooled condenser 14, the three-way valve 30 is connected to an inlet of the coolant passage, and the eight-way valve 40 is connected to an outlet of the coolant passage.

As described above, the chiller 16 is configured to function as the evaporator that cools the coolant, which circulates through the fluid circuit system 20, by using the low-pressure refrigerant depressurized in the second expansion valve 17b, and the chiller 16 is also configured to function as the heater that heats the coolant. The chiller 16 functions as a heat exchange unit that is configured to exchange heat between: the coolant, which has previously exchanged heat with at least one of the electric drive units 23 and the battery 24; and the refrigerant. The eight-way valve 40 is connected to an inlet and an outlet of the coolant passage of the chiller 16.

The radiator 22 is a water–outside-air heat exchanger that is configured to exchange heat between: the coolant, which has been heated or cooled in the chiller 16; and the outside air, which is blown by an outside-air fan (not shown). The radiator 22 is, for example, arranged on a front side of a drive device that drives the vehicle. The eight-way valve 40 is connected to an inlet and an outlet of the radiator 22.

The battery 24 is a secondary battery that is configured to supply electric power to an inverter 23b (described later) of the electric drive unit 23 and to the compressor 12 of the refrigeration cycle 10 and is also configured to store electric power by being charged. The battery 24 is a battery module formed by electrically connecting a plurality of battery cells in series or parallel. For example, a lithium-ion battery can be used as the battery 24.

The battery 24 generates heat by itself when the battery 24 supplies the charged electric power to the outside. Furthermore, the battery 24, which is the secondary battery, tends to experience a decrease in output at low temperatures and tends to deteriorate more easily at high temperatures. For this reason, the temperature of the battery 24 must be maintained at a level that ensures the output required for driving of the vehicle and that suppresses deterioration, even in a low-temperature environment where the outside air temperature is relatively low.

For this reason, the battery 24 is received in a battery case, and a coolant passage is formed inside the battery case to allow the coolant, which is the heat medium circulating through the fluid circuit system 20, to flow therethrough. The coolant passage is formed so as to uniformly regulate the temperature of all of the battery cells. The coolant passage is formed so as to perform heat exchange between: the coolant, which flows through the coolant passage; and the battery 24, which has stored heat, so that the heat stored in the battery 24 can be transferred to the coolant.

The battery 24 has a relatively low internal temperature in a state where the temperature of the outside air is low, and little time has elapsed since the start of power supply, such as immediately after the start of power supply to the inverter 23b and the compressor 12. In such a case, when the coolant, which has the temperature higher than the temperature of the battery 24, flows through the coolant passage, the battery 24 absorbs heat from the coolant and is thereby heated. The eight-way valve 40 is connected to an inlet and an outlet of a coolant passage of the battery 24.

Furthermore, in a state where some time has elapsed since the start of power supply to the inverter 23b and the compressor 12, the internal temperature of the battery 24 rises due to its own heat generation. In such a case, when the coolant, which has the temperature lower than the temperature of the battery 24, flows through the coolant passage, the battery 24 releases heat to the coolant and is thereby cooled.

The electric drive unit 23 is an electric component that outputs a drive force for driving the electric vehicle. The electric drive unit 23 includes: a DC-DC converter 23a and the inverter 23b that adjust the voltage supplied from the battery 24; a motor generator 23c that outputs the drive force for driving the vehicle; and an MG oil cooler 23d that cools the motor generator 23c. Among the components of the electric drive unit 23, the DC-DC converter 23a, the inverter 23b and the motor generator 23c are heat generating devices that generate heat during operation.

The DC-DC converter 23a is a step-down converter that steps down the high voltage, which is supplied from the battery 24, to a low voltage. The DC-DC converter 23a converts the high voltage supplied from the battery 24 into a low voltage (for example, 12 V) for driving an auxiliary device 50 mounted on the electric vehicle and outputs the low voltage to the auxiliary device 50. A coolant passage for conducting the coolant (serving as the heat medium), which is circulated through the fluid circuit system 20, is formed inside the DC-DC converter 23a. The eight-way valve 40 is connected to an inlet of the coolant passage of the DC-DC converter 23a, and a coolant passage of the inverter 23b described later is connected to an outlet of the DC-DC converter 23a.

The inverter 23b converts the direct-current (DC) voltage supplied from the battery 24 into an alternating-current (AC) voltage. The inverter 23b converts the DC voltage supplied by the battery 24 into the AC voltage and outputs it to a traction motor of the motor generator 23c. The coolant passage for conducting the coolant (serving as the heat medium), which is circulated through the fluid circuit system 20, is formed inside the inverter 23b. The coolant passage of the DC-DC converter 23a is connected to an inlet of the coolant passage of the inverter 23b, and a coolant passage (described later) of the MG oil cooler 23d is connected to an outlet of the coolant passage of the inverter 23b.

The motor generator 23c functions both as a traction electric motor that outputs the drive force for driving the vehicle using the electric power supplied from the inverter 23b, and as a generator that generates regenerative electric power during vehicle deceleration or downhill driving. The motor generator 23c is connected to the MG oil cooler 23d via an oil passage 23e that circulates oil for smoothly driving the electric motor.

The MG oil cooler 23d cools the oil by exchanging heat between the coolant circulating through the fluid circuit system 20 and the oil for smoothly driving the electric motor of the motor generator 23c. The MG oil cooler 23d supplies the cooled oil to the motor generator 23c, thereby indirectly cooling the motor generator 23c using the coolant circulating through the fluid circuit system 20. The coolant passage for conducting the coolant (serving as the heat medium), which is circulated through the fluid circuit system 20, is formed inside the MG oil cooler 23d. An inlet of the coolant passage of the MG oil cooler 23d is connected to the coolant passage of the inverter 23b, and an outlet of the coolant passage of the MG oil cooler 23d is connected to the three-way valve 30.

The first pump 25a, the second pump 25b and the third pump 25c generate a flow of the coolant through the coolant circulation passage 21.

Specifically, each of the first pump 25a, the second pump 25b and the third pump 25c is an electric pump that pumps the coolant flowing through the coolant circulation passage 21 toward the downstream side thereof. Each of the first pump 25a, the second pump 25b and the third pump 25c is electrically connected to the controller device 60, and a rotational speed, i.e., a pumping capacity of the pump 25a, 25b, 25c is controlled by a control signal outputted from the controller device 60.

The first pump 25a is provided between the chiller 16 and the eight-way valve 40. Specifically, the first pump 25a is provided in a portion of the coolant circulation passage 21 which connects between the inlet of the coolant passage of the chiller 16 and the eight-way valve 40. The first pump 25a generates a flow of the coolant from the eight-way valve 40 toward the chiller 16.

The second pump 25b is provided between the battery 24 and the eight-way valve 40. Specifically, the second pump 25b is provided in a portion of the coolant circulation passage 21 which connects between the inlet of the coolant passage of the battery 24 and the eight-way valve 40. The second pump 25b generates a flow of the coolant from the eight-way valve 40 toward the battery 24.

The third pump 25c is provided between the DC-DC converter 23a and the eight-way valve 40. Specifically, the third pump 25c is provided in a portion of the coolant circulation passage 21 which connects between the inlet of the coolant passage of the DC-DC converter 23a and the eight-way valve 40. The third pump 25c generates a flow of the coolant from the eight-way valve 40 toward the DC-DC converter 23a. Each of the first pump 25a, the second pump 25b and the third pump 25c functions as a pumping unit that pumps the coolant through the coolant circulation passage 21.

The three-way valve 30 has one flow inlet and two flow outlets and is a valve that directs the coolant flowing in from the one flow inlet to a corresponding one of the flow outlets that corresponds to an operating mode of the temperature adjustment device 1. The three-way valve 30 is provided between the MG oil cooler 23d and the water-cooled condenser 14. The three-way valve 30 has a three-way inlet 30a connected to the outlet of the coolant passage of the MG oil cooler 23d. Furthermore, the three-way valve 30 has: a three-way first outlet 30b connected to the inlet of the water-cooled condenser 14; and a three-way second outlet 30c connected to an inlet of a bypass passage 21a that bypasses the water-cooled condenser 14 in the coolant circulation passage 21.

The bypass passage 21a is a passage that guides the coolant flowing out from the outlet of the coolant passage of the MG oil cooler 23d to the eight-way valve 40. An outlet of the bypass passage 21a is connected between the outlet of the water-cooled condenser 14 and the eight-way valve 40 in the coolant circulation passage 21.

The three-way valve 30 is an electric valve device that includes: a valve element, a rotational position of which can be changed; and an electric actuator, which is configured to change the rotational position of the valve element. The three-way valve 30 is configured such that, by adjusting the rotational position of the valve element, the outlet communicating with the three-way inlet 30a is switched between the three-way first outlet 30b and the three-way second outlet 30c. The three-way valve 30 is electrically connected to the controller device 60, and the rotational position of the valve element is controlled by a control signal outputted from the controller device 60.

The eight-way valve 40 is a circuit switching device that has four flow inlets and four flow outlets and guides the coolant flowing in from one or more of the four flow inlets to corresponding one or more of the four flow outlets which corresponds to the operating mode of the temperature adjustment device 1. The eight-way valve 40 has: an eight-way first inlet 40a connected to the outlet of the radiator 22; and an eight-way second inlet 40b connected to the outlet of the coolant passage of the chiller 16. Furthermore, the eight-way valve 40 has: an eight-way third inlet 40c connected to the outlet of the coolant passage of the battery 24; and an eight-way fourth inlet 40d connected to the outlet of the coolant passage of the water-cooled condenser 14.

Furthermore, the eight-way valve 40 has: an eight-way first outlet 40e connected to the inlet of the radiator 22; and an eight-way second outlet 40f connected to the inlet of the coolant passage of the chiller 16. Furthermore, the eight-way valve 40 has: an eight-way third outlet 40g connected to the inlet of the coolant passage of the battery 24; and an eight-way fourth outlet 40h connected to the inlet of the coolant passage of the DC-DC converter 23a.

The eight-way valve 40 is an electric valve device that includes: a valve element, a rotational position of which can be changed; and an electric actuator, which is configured to change an opening degree of the valve element. By adjusting the rotational position of the valve element, the eight-way valve 40 changes which outlets among the eight-way first outlet 40e, the eight-way second outlet 40f, the eight-way third outlet 40g and the eight-way fourth outlet 40h communicate with corresponding inlets among the eight-way first inlet 40a, the eight-way second inlet 40b, the eight-way third inlet 40c and the eight-way fourth inlet 40d.

For example, the eight-way valve 40 is configured such that, by adjusting the rotational position of the valve element, the eight-way first inlet 40a can be brought into communication with the eight-way second outlet 40f. Furthermore, the eight-way valve 40 is configured such that, by adjusting the rotational position of the valve element, the eight-way second inlet 40b can be brought into communication with one of the eight-way first outlet 40e, the eight-way third outlet 40g and the eight-way fourth outlet 40h. Furthermore, the eight-way valve 40 is configured such that, by adjusting the rotational position of the valve element, the eight-way third inlet 40c can be brought into communication with either the eight-way third outlet 40g or the eight-way fourth outlet 40h. Furthermore, the eight-way valve 40 is configured such that, by adjusting the rotational position of the valve element, the eight-way fourth inlet 40d can be brought into communication with either the eight-way second outlet 40f or the eight-way third outlet 40g. The eight-way valve 40 is electrically connected to the controller device 60, and the rotational position of the valve element is controlled by a control signal outputted from the controller device 60.

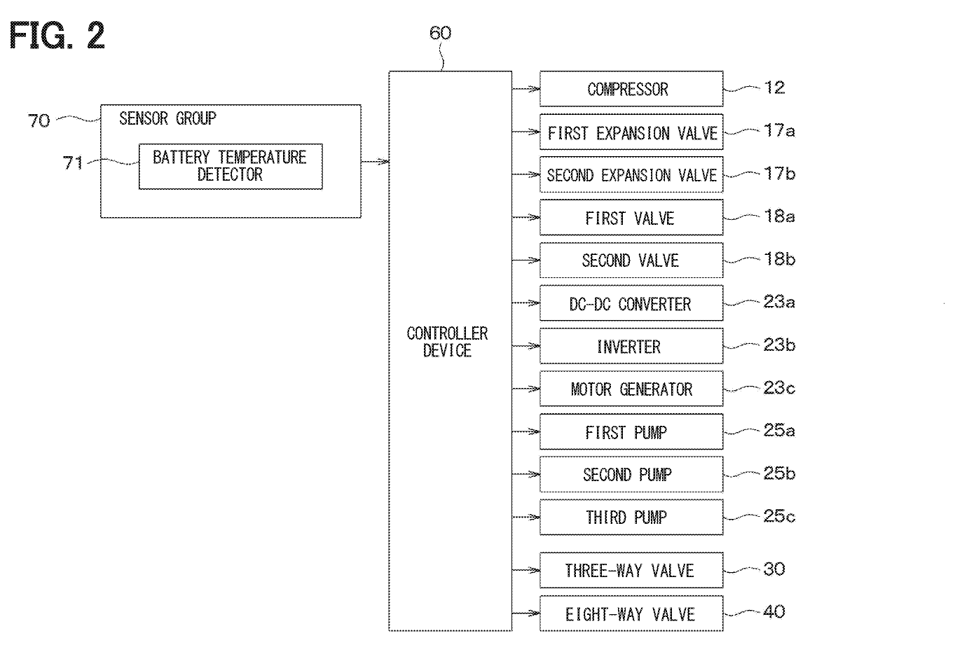

Next, an overview of the controller device 60 of the present embodiment will be described with reference to FIG. 2. The controller device 60 includes: a microcomputer, which includes a CPU, a ROM and a RAM; and a peripheral circuit of the microcomputer. The controller device 60 performs various calculations and processes based on a control program stored in the ROM and controls the operation of various control subject devices connected to its output side. Each of the ROM and the RAM of the controller device 60 is formed by a non-transitory tangible storage medium. For example, the controller device 60 can be an air-conditioning ECU that controls the operation of various components of the vehicle air-conditioning device. Here, ECU stands for Electronic Control Unit.

As shown in FIG. 2, a sensor group 70, which obtains information for controlling the operation of the temperature adjustment device 1, is connected to an input side of the controller device 60. The sensor group 70 includes a battery temperature detector 71 that detects a battery temperature Tb, which is a temperature of the battery 24. The battery temperature detector 71 is a temperature sensor that detects the battery temperature Tb.

Note that the sensor group 70 may include a voltage sensor that detects the voltage of the battery 24, an outside-air temperature sensor that detects the temperature of the air outside the vehicle cabin, an inside-air temperature sensor that detects the temperature of the air inside the vehicle cabin, and/or a solar radiation sensor that detects the amount of solar radiation irradiated into the vehicle cabin. Various detection signals, which correspond to the information detected by the sensor group 70, are inputted to the controller device 60.

The battery temperature detector 71 includes, for example, a plurality of temperature sensors and detects the temperature of each of the battery cells included in the battery 24 and uses an average of the detection values of the respective temperature sensors as the battery temperature Tb.

Further, as shown in FIG. 2, the compressor 12, the first expansion valve 17a, the second expansion valve 17b, the first valve 18a and the second valve 18b of the refrigeration cycle 10 are connected to an output side of the controller device 60. Further, the DC-DC converter 23a, the inverter 23b, the motor generator 23c, the first pump 25a, the second pump 25b, the third pump 25c, the three-way valve 30 and the eight-way valve 40 of the fluid circuit system 20 are connected to the output side of the controller device 60. The controller device 60 of the present embodiment controls the operation of the various control subject devices connected to the output side of the controller device 60 based on the various detection signals inputted from the sensor group 70. For example, the controller device 60 changes the rotational position of the valve element of each of the three-way valve 30 and the eight-way valve 40 based on the battery temperature Tb detected by the battery temperature detector 71, thereby making the three-way valve 30 and the eight-way valve 40 correspond to the respective operating modes of the temperature adjustment device 1.

Next, the operating modes of the temperature adjustment device 1 of the present embodiment will be described. The temperature adjustment device 1 of the present embodiment can switch the heat source, which is used by the vehicle air-conditioning device to heat the vehicle cabin, by switching the operating mode. For example, the vehicle air-conditioning device, which is applied to the electric vehicle, heats the vehicle cabin by utilizing heat contained in the air in situations where it is difficult to obtain heat from various heat generating devices, such as immediately after the start of driving of the vehicle. Further, when sufficient heat can be obtained from the various heat generating devices, such as after some time has elapsed since the start of driving of the vehicle, the vehicle air-conditioning device heats the vehicle cabin by utilizing the heat generated by the operation of the various heat generating devices.

The temperature adjustment device 1 switches the operating mode and controls the operation of the three-way valve 30 and the eight-way valve 40 depending on whether the vehicle air-conditioning device heats the vehicle cabin by utilizing heat contained in the air or by utilizing heat generated through the operation of the heat generating devices.

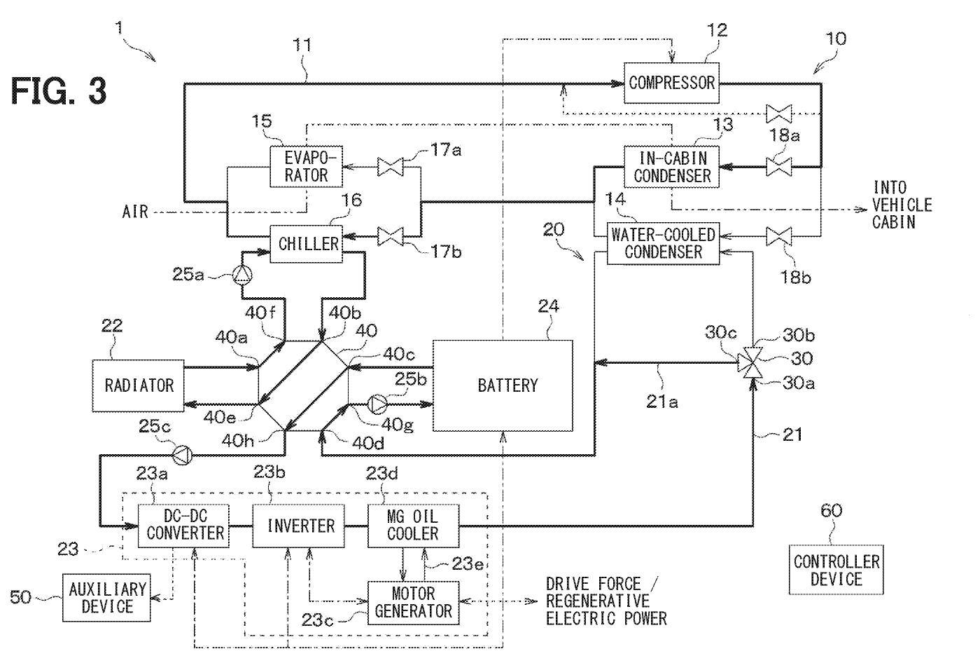

Hereinafter, among the operating modes executable by the temperature adjustment device 1 of the present embodiment, the flows of the refrigerant and the coolant in each of three representative operating modes will be described with reference to FIGS. 3 to 5. In FIGS. 3 to 5, the flow of the refrigerant, which circulates through the refrigeration cycle 10, is indicated by bold arrows, which are thicker than arrows that indicate the refrigerant circulation passage 11, and the flow of the coolant, which circulates through the fluid circuit system 20, is indicated by bold arrows, which are thicker than arrows that indicate the coolant circulation passage 21.

Note that the following description of the three operating modes refers to the operating modes when the vehicle air-conditioning device is operated to heat the vehicle cabin, but the temperature adjustment device 1 of the present embodiment can also be used in a vehicle air-conditioning device that can cool the vehicle cabin. In addition, the following description of the three operating modes illustrates the operating mode in which the battery 24 is heated, but the temperature adjustment device 1 of the present embodiment is also capable of executing an operating mode in which the battery 24 is cooled by switching the flow of the refrigerant and the coolant.

### (1) First Mode

The first mode is an operating mode that performs the heating of the vehicle cabin by utilizing heat contained in the ambient air. As shown in FIG. 3, in the first mode, the controller device 60 opens the first valve 18a, closes the second valve 18b and the first expansion valve 17a, and opens the second expansion valve 17b.

Furthermore, in the first mode, the controller device 60 rotates the valve element of the three-way valve 30 so as to communicate the three-way inlet 30a with the three-way second outlet 30c. Furthermore, in the first mode, the controller device 60 rotates the valve element of the eight-way valve 40 so as to communicate the eight-way first inlet 40a with the eight-way second outlet 40f and to communicate the eight-way second inlet 40b with the eight-way first outlet 40e. Furthermore, in the first mode, the controller device 60 rotates the valve element of the eight-way valve 40 so as to communicate the eight-way third inlet 40c with the eight-way fourth outlet 40h and to communicate the eight-way fourth inlet 40d with the eight-way third outlet 40g.

As a result, in the first mode, in the refrigeration cycle 10, the refrigerant circulates in the order of the compressor 12, the first valve 18a, the in-cabin condenser 13, the second expansion valve 17b and the refrigerant passage of the chiller 16. Furthermore, in the first mode, in the fluid circuit system 20, the coolant flows in the order of the first pump 25a, the coolant passage of the chiller 16, the eight-way valve 40 and the radiator 22, and circulates between the chiller 16 and the radiator 22. Furthermore, in the first mode, in the fluid circuit system 20, the coolant flows in the order of the third pump 25c, the coolant passage of the DC-DC converter 23a, the coolant passage of the inverter 23b, the coolant passage of the MG oil cooler 23d, the three-way valve 30, the bypass passage 21a, the second pump 25b, the coolant passage of the battery 24 and the eight-way valve 40. That is, the coolant circulates among the DC-DC converter 23a, the inverter 23b, the MG oil cooler 23d and the battery 24.

In the first mode in which the refrigerant and the coolant circulate in this manner, the coolant absorbs heat (ambient heat) from the outside air in the radiator 22 and is thereby heated. Furthermore, by performing heat exchange between the heated coolant and the refrigerant in the chiller 16 to heat the refrigerant, heat from the outside air can be used for heating the vehicle cabin. Note that the vehicle air-conditioning device heats the blown air by performing heat exchange between: the high-temperature, high-pressure refrigerant, which is discharged from the compressor 12; and the blown air, which passes through the in-cabin condenser 13.

Furthermore, in the first mode, the coolant, which passes through the DC-DC converter 23a, the inverter 23b, the motor generator 23c and the battery 24, is heated by heat generated by each of these heat-generating devices. Furthermore, by circulating the heated coolant in the coolant circulation passage 21, the heat generation of each of the DC-DC converter 23a, the inverter 23b, the motor generator 23c and the battery 24 can be used to heat the battery 24. That is, in the first mode, the temperature adjustment device 1 recovers waste heat that is generated by operation of the DC-DC converter 23a, the inverter 23b and the motor generator 23c, and uses this otherwise unnecessary heat to heat the battery 24, and additionally heats the battery 24 by the heat generated by the battery 24 itself.

In this manner, in the first mode, the eight-way valve 40 switches the coolant circulation passage 21 to form a first circuit that guides the coolant, which has previously exchanged heat in the electric drive unit 23, to the battery 24. The first circuit is formed by the eight-way valve 40, the second pump 25b, the third pump 25c and the piping, which forms the coolant circulation passage 21.

### (2) Second Mode

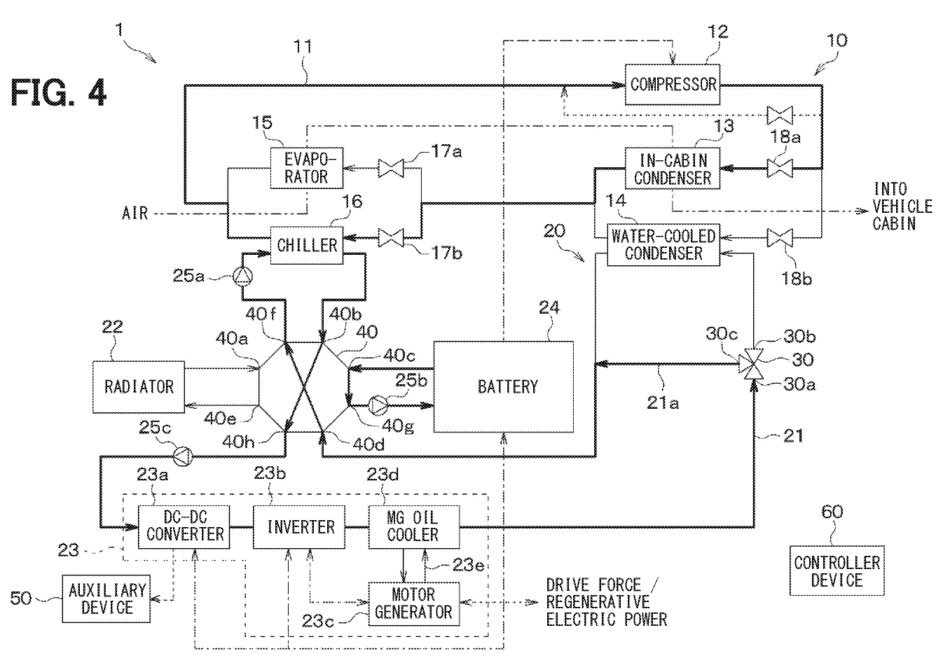

The second mode is an operating mode in which the heat generation of the DC-DC converter 23a, the inverter 23b and the motor generator 23c is utilized to heat the vehicle cabin, while the own heat generation of the battery 24 is utilized to heat the battery 24 itself. As shown in FIG. 4, in the second mode, the controller device 60 opens the first valve 18a, closes the second valve 18b and the first expansion valve 17a, and opens the second expansion valve 17b, in the same manner as in the first mode.

Furthermore, in the second mode, the controller device 60 rotates the valve element of the three-way valve 30 so as to communicate the three-way inlet 30a with the three-way second outlet 30c, in the same manner as in the first mode. However, in the second mode, the controller device 60 rotates the valve element of the eight-way valve 40 so as to communicate the eight-way second inlet 40b with the eight-way fourth outlet 40h and to communicate the eight-way third inlet 40c with the eight-way third outlet 40g. Furthermore, in the second mode, the controller device 60 rotates the valve element of the eight-way valve 40 so as to communicate the eight-way fourth inlet 40d with the eight-way second outlet 40f.

As a result, in the second mode, in the refrigeration cycle 10, the refrigerant circulates in the order of the compressor 12, the first valve 18a, the in-cabin condenser 13, the second expansion valve 17b and the refrigerant passage of the chiller 16. Furthermore, in the second mode, in the fluid circuit system 20, the coolant flows in the order of the first pump 25a, the coolant passage of the chiller 16, the eight-way valve 40, the third pump 25c, the coolant passage of the DC-DC converter 23a, the coolant passage of the inverter 23b, the coolant passage of the MG oil cooler 23d, the three-way valve 30, the bypass passage 21a and the eight-way valve 40. That is, the coolant circulates among the chiller 16, the DC-DC converter 23a, the inverter 23b and the MG oil cooler 23d. Furthermore, in the second mode, in the fluid circuit system 20, the coolant flows in the order of the second pump 25b, the coolant passage of the battery 24 and the eight-way valve 40. That is, the coolant circulates between the battery 24 and the eight-way valve 40 while bypassing the chiller 16 and the electric drive unit 23.

In the second mode during which the refrigerant and the coolant circulate in this manner, the coolant, which passes through the DC-DC converter 23a, the inverter 23b and the motor generator 23c, is heated by the heat generated by the operation of these heat-generating devices. Furthermore, by exchanging heat between the heated coolant and the refrigerant in the chiller 16 to heat the refrigerant, the heat generated by the operation of the DC-DC converter 23a, the inverter 23b and the motor generator 23c can be used for heating the vehicle cabin. That is, in the second mode, the temperature adjustment device 1 recovers the waste heat generated by the operation the DC-DC converter 23a, the inverter 23b and the motor generator 23c, and uses the recovered waste heat to heat the vehicle cabin.

Furthermore, in the second mode, the coolant, which passes through the battery 24, is heated by the heat generated by the operation of the battery 24. Furthermore, by returning the heated coolant to the battery 24 in the coolant circulation passage 21 without passing through the chiller 16 and the electric drive unit 23, the battery 24 is warmed by its own heat so that the temperature of the battery 24 is maintained at a constant level.

In this manner, in the second mode, the eight-way valve 40 switches the coolant circulation passage 21 to form a second circuit that guides the coolant, which has previously exchanged heat with the electric drive unit 23, to the chiller 16. The second circuit is formed by the eight-way valve 40, the first pump 25a, the third pump 25c and the piping, which forms the coolant circulation passage 21.

Furthermore, in the second mode, the eight-way valve 40 switches the coolant circulation passage 21 to form a third circuit that returns the coolant, which has previously exchanged heat with the battery 24, to the battery 24 while bypassing the electric drive unit 23 and the chiller 16. The third circuit is formed by the eight-way valve 40, the second pump 25b and the piping, which forms the coolant circulation passage 21. The eight-way valve 40 simultaneously forms the third circuit at the time of forming the second circuit.

### (3) Third Mode

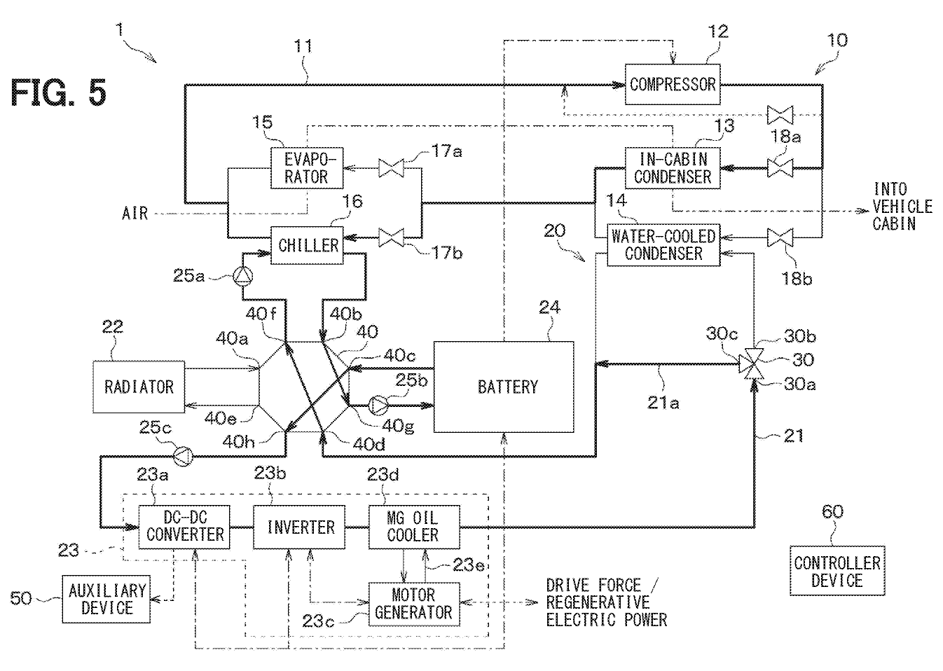

The third mode is an operating mode in which the heat generation of the DC-DC converter 23a, the inverter 23b, the motor generator 23c and the battery 24 is utilized to heat the vehicle cabin. As shown in FIG. 5, in the third mode, the controller device 60 opens the first valve 18a, closes the second valve 18b and the first expansion valve 17a, and opens the second expansion valve 17b, in the same manner as in the first mode and the second mode.

Furthermore, in the third mode, the controller device 60 rotates the valve element of the three-way valve 30 so as to communicate the three-way inlet 30a with the three-way second outlet 30c, in the same manner as in the first mode and the second mode. However, in the third mode, the controller device 60 rotates the valve element of the eight-way valve 40 so as to communicate the eight-way second inlet 40b with the eight-way third outlet 40g and to communicate the eight-way third inlet 40c with the eight-way fourth outlet 40h. Furthermore, in the third mode, the controller device 60 rotates the valve element of the eight-way valve 40 so as to communicate the eight-way fourth inlet 40d with the eight-way second outlet 40f.

As a result, in the third mode, in the refrigeration cycle 10, the refrigerant circulates in the order of the compressor 12, the first valve 18a, the in-cabin condenser 13, the second expansion valve 17b and the refrigerant passage of the chiller 16. Furthermore, in the third mode, in the fluid circuit system 20, the coolant flows in the order of the first pump 25a, the coolant passage of the chiller 16, the eight-way valve 40, the second pump 25b, the coolant passage of the battery 24, the eight-way valve 40, the third pump 25c, the coolant passage of the DC-DC converter 23a, the coolant passage of the inverter 23b, the coolant passage of the MG oil cooler 23d, the three-way valve 30, the bypass passage 21a and the eight-way valve 40. That is, the coolant circulates among the chiller 16, the battery 24, the DC-DC converter 23a, the inverter 23b and the MG oil cooler 23d.

In the third mode during which the refrigerant and the coolant circulate in this manner, the coolant, which passes through the DC-DC converter 23a, the inverter 23b, the motor generator 23c and the battery 24, is heated by the heat generated by the operation of these heat-generating devices. Furthermore, by exchanging heat between the heated coolant and the refrigerant in the chiller 16 to heat the refrigerant, the heat generated by the operation of the DC-DC converter 23a, the inverter 23b, the motor generator 23c and the battery 24 can be used for heating the vehicle cabin. That is, in the third mode, the temperature adjustment device 1 recovers the waste heat generated by the operation of the DC-DC converter 23a, the inverter 23b and the motor generator 23c and the battery 24 and uses the recovered waste heat to heat the vehicle cabin.

In this manner, in the third mode, the eight-way valve 40 switches the coolant circulation passage 21 to form a fourth circuit that guides the coolant, which has previously exchanged heat with the electric drive unit 23 and the battery 24, to the chiller 16. The fourth circuit is formed by the eight-way valve 40, the first pump 25a, the second pump 25b, the third pump 25c and the piping, which forms the coolant circulation passage 21.

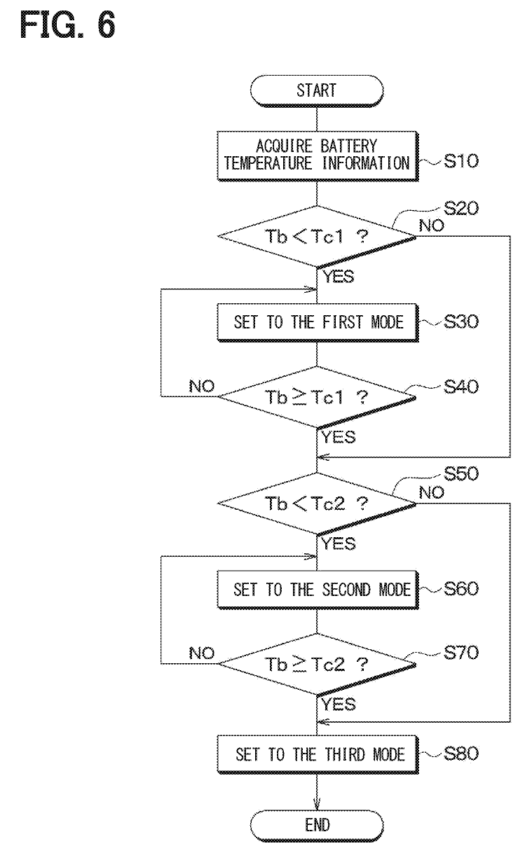

These operating modes are switched by the controller device 60 of the temperature adjustment device 1 when the vehicle air-conditioning device heats the vehicle cabin. The operation of the temperature adjustment device 1 of the present embodiment will be described with reference to a control flow shown in FIG. 6 that is executed by the controller device 60.

When the vehicle air-conditioning device performs the heating, first, in step S10, the controller device 60 reads the detection signal inputted from the battery temperature detector 71 and acquires information of the battery temperature Tb. Next, in step S20, the controller device 60 determines whether the battery temperature Tb is lower than a first determination temperature Tc1.

The first determination temperature Tc1 is a temperature stored in advance in the controller device 60 and is set at an appropriate temperature for the battery 24 that enables the output required to drive the traction motor to be obtained from the battery 24 even in the low-temperature environment where the temperature of the outside air is relatively low. For example, the first determination temperature Tc1 is set at a predetermined temperature (for example, 5°C) within a range of 0°C to 10°C. Note that the first determination temperature Tc1 is not limited to 5°C and may be set at a temperature lower than 5°C or higher than 5°C as long as it is a temperature at which the output required to drive the traction motor can be obtained from the battery 24.

If the controller device 60 does not determine that the battery temperature Tb is lower than the first determination temperature Tc1, the controller device 60 skips the operations in step S30 and step S40 and proceeds to the operation in step S50.

In contrast, when the controller device 60 determines that the battery temperature Tb is lower than the first determination temperature Tc1, the controller device 60 sets the operating mode to the first mode in step S30. Specifically, the controller device 60 opens the first valve 18a, closes the second valve 18b and the first expansion valve 17a, and opens the second expansion valve 17b. Furthermore, the controller device 60 rotates the valve element of the three-way valve 30 so as to communicate the three-way inlet 30a with the three-way second outlet 30c in the three-way valve 30. Furthermore, the controller device 60 communicates the eight-way first inlet 40a with the eight-way second outlet 40f in the eight-way valve 40 and communicates the eight-way second inlet 40b with the eight-way first outlet 40e in the eight-way valve 40. Furthermore, the controller device 60 communicates the eight-way third inlet 40c with the eight-way fourth outlet 40h in the eight-way valve 40 and communicates the eight-way fourth inlet 40d with the eight-way third outlet 40g in the eight-way valve 40.

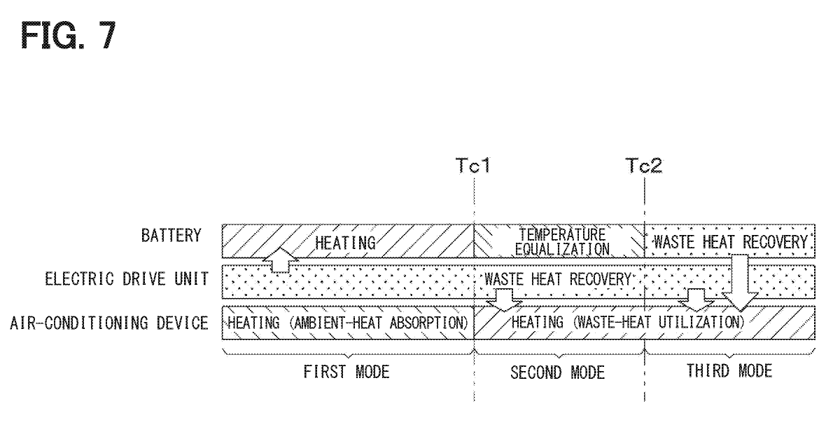

As a result, as shown in FIG. 7, in the first mode, the vehicle air-conditioning device heats the vehicle cabin by using heat from the outside air. Furthermore, the temperature adjustment device 1 recovers the waste heat that is generated by operation of the DC-DC converter 23a, the inverter 23b and the motor generator 23c of the electric drive unit 23, and uses this otherwise unnecessary heat to heat the battery 24, and additionally heats the battery 24 by the heat generated by the battery 24 itself.

Then, in step S40, the controller device 60 determines whether the battery temperature Tb is equal to or higher than the first determination temperature Tc1. The controller device 60 maintains the operating mode in the first mode until the battery temperature Tb reaches the first determination temperature Tc1 or higher. When the controller device 60 determines that the battery temperature Tb is equal to or higher than the first determination temperature Tc1, the controller device 60 executes the operation of step S50.

Next, in step S50, the controller device 60 determines whether the battery temperature Tb is lower than a second determination temperature Tc2.

If the controller device 60 determines that the battery temperature Tb is not lower than the second determination temperature Tc2, the controller device 60 skips the operations in step S60 and step S70 and proceeds to the operation in step S80.

In contrast, when the controller device 60 determines that the battery temperature Tb is lower than the second determination temperature Tc2, the controller device 60 sets the operating mode to the second mode in step S60. Specifically, the controller device 60 opens the first valve 18a, closes the second valve 18b and the first expansion valve 17a, and opens the second expansion valve 17b. Furthermore, the controller device 60 rotates the valve element of the three-way valve 30 so as to communicate the three-way inlet 30a with the three-way second outlet 30c in the three-way valve 30. Furthermore, the controller device 60 communicates the eight-way second inlet 40b with the eight-way fourth outlet 40h in the eight-way valve 40 and communicates the eight-way third inlet 40c with the eight-way third outlet 40g in the eight-way valve 40. Furthermore, the controller device 60 communicates the eight-way fourth inlet 40d with the eight-way second outlet 40f in the eight-way valve 40.

As a result, as shown in FIG. 7, in the second mode, the vehicle air-conditioning device heats the vehicle cabin by using the waste heat from each of the DC-DC converter 23a, the inverter 23b and the motor generator 23c of the electric drive unit 23. Furthermore, the temperature adjustment device 1 heats the battery 24 by the heat generated by the battery 24 itself so that the temperature of the battery 24 is maintained at a constant level.

Then, in step S70, the controller device 60 determines whether the battery temperature Tb is equal to or higher than the second determination temperature Tc2. The controller device 60 maintains the operating mode in the second mode until the battery temperature Tb reaches the second determination temperature Tc2 or higher. When the controller device 60 determines that the battery temperature Tb is equal to or higher than the second determination temperature Tc2, the controller device 60 executes the operation of step S80.

The second determination temperature Tc2 is a temperature stored in advance in the controller device 60 and is set at a temperature at which the battery 24 can output the power required to drive the traction motor even when the own heat generation of the battery 24 is utilized for heating the vehicle cabin. The second determination temperature Tc2 is set at a temperature higher than the first determination temperature Tc1. For example, the second determination temperature Tc2 is set at a predetermined temperature (for example, 15°C) within a range of 10°C to 20°C. Note that the second determination temperature Tc2 is not limited to 15°C and may be set at a temperature lower than 15°C or higher than 15°C as long as it is a temperature at which the output required to drive the traction motor can be obtained from the battery 24.

When the controller device 60 determines that the battery temperature Tb is equal to or higher than the second determination temperature Tc2 in step S70, the controller device 60 sets the operating mode to the third mode in step S80. Specifically, the controller device 60 opens the first valve 18a, closes the second valve 18b and the first expansion valve 17a, and opens the second expansion valve 17b. Furthermore, the controller device 60 rotates the valve element of the three-way valve 30 so as to communicate the three-way inlet 30a with the three-way second outlet 30c in the three-way valve 30. Furthermore, the controller device 60 communicates the eight-way second inlet 40b with the eight-way third outlet 40g in the eight-way valve 40 and communicates the eight-way third inlet 40c with the eight-way fourth outlet 40h in the eight-way valve 40. Furthermore, the controller device 60 communicates the eight-way fourth inlet 40d with the eight-way second outlet 40f in the eight-way valve 40.

As a result, as shown in FIG. 7, in the third mode, the vehicle air-conditioning device heats the vehicle cabin by using the waste heat from each of the DC-DC converter 23a, the inverter 23b and the motor generator 23c of the electric drive unit 23 and the battery 24.

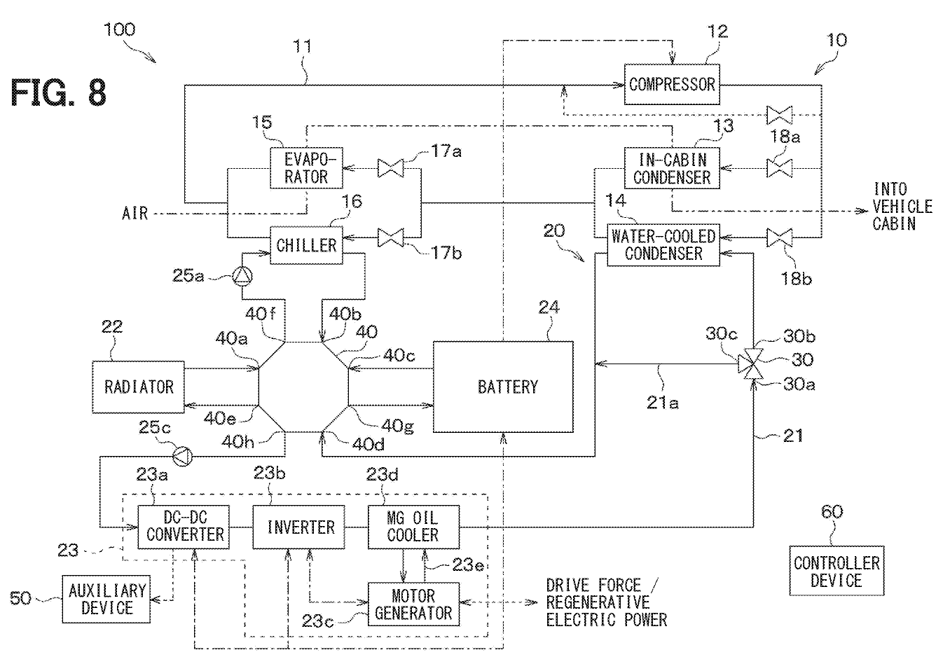

In this manner, the temperature adjustment device 1 of the present embodiment changes the operating mode in the order of the first mode, the second mode and the third mode in accordance with the battery temperature Tb of the battery 24, and switches the refrigerant circulation passage 11 and the coolant circulation passage 21 by means of the three-way valve 30 and the eight-way valve 40. The reason why the operating mode during the heating by the vehicle air-conditioning device is changed among the three modes in this manner will be explained using a comparative temperature adjustment device 100 shown in FIG. 8 as a comparative example. Compared with the temperature adjustment device 1, the comparative temperature adjustment device 100 is incapable of executing the second mode, and accordingly, as shown in FIG. 8, the second pump 25b is eliminated.

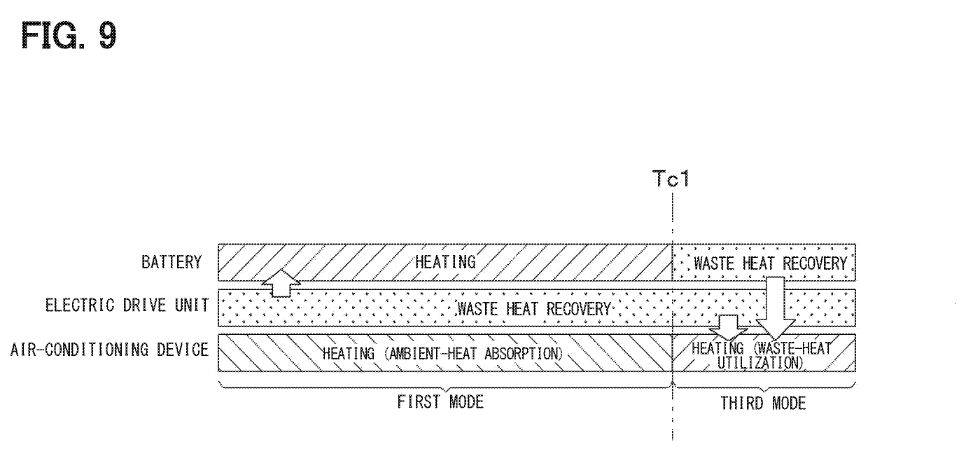

As shown in FIG. 9, in the first mode, the comparative temperature adjustment device 100 recovers the waste heat from each of the DC-DC converter 23a, the inverter 23b and the motor generator 23c to heat the battery 24, and also heats the battery 24 by the heat generated by the battery 24 itself. In this case, in the first mode, the vehicle air-conditioning device heats the vehicle cabin by using the heat from the outside air.

Furthermore, when the battery temperature Tb reaches or exceeds the first determination temperature Tc1, the comparative temperature adjustment device 100 sets the operating mode to the third mode. As a result, in the third mode, the vehicle air-conditioning device heats the vehicle cabin using the waste heat from each of the DC-DC converter 23a, the inverter 23b, the motor generator 23c and the battery 24.

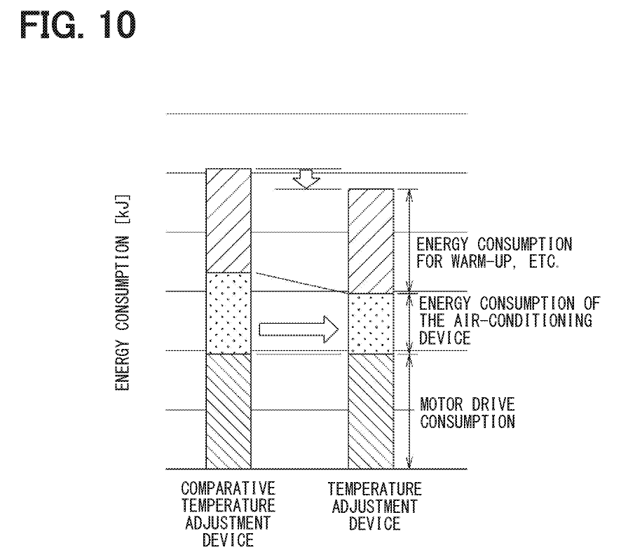

The difference in the amount of energy consumption of the battery 24 between the temperature adjustment device 1 (which executes the second mode) and the comparative temperature adjustment device 100 (which does not execute the second mode) will be described with reference to FIG. 10. FIG. 10 shows, in the case where the temperature of the outside air is -10°C, which is a relatively low-temperature environment, the energy consumption caused by driving of the traction motor, the energy consumption caused by operation of the vehicle air-conditioning device, and the energy consumption caused by warm-up operation of the vehicle, respectively.

As shown in FIG. 10, the temperature adjustment device 1, which executes the second mode, can reduce the energy consumption caused by the operation of the vehicle air-conditioning device by approximately 25% compared to the comparative temperature adjustment device 100, which does not execute the second mode. As a result, the temperature adjustment device 1 can reduce the total energy consumption of the battery 24 by approximately 7% compared to the comparative temperature adjustment device 100.

The reason why the temperature adjustment device 1 can reduce the energy consumption of the battery 24 compared to the comparative temperature adjustment device 100 will now be explained.

In the second mode, the heating of the battery 24 is performed by the own heat generation of the battery 24 itself. Furthermore, in the second mode, the temperature adjustment device 1 utilizes all of the waste heat from the electric drive unit 23 to heat the vehicle cabin. For this reason, in the second mode, the energy consumption at the time of performing the heating by the vehicle air-conditioning device is suppressed compared to the first mode, in which the battery 24 is heated by using the waste heat from the electric drive unit 23 while the vehicle cabin is heated by using the heat from the outside air. Therefore, the temperature adjustment device 1, which executes the second mode, can reduce the energy consumption caused by the operation of the vehicle air-conditioning device compared to the comparative temperature adjustment device 100, which does not execute the second mode. As a result, the temperature adjustment device 1 can reduce the energy consumption of the battery 24.

As described above, in the temperature adjustment device 1 of the present embodiment, the eight-way valve 40 switches the coolant circulation passage 21 to form the first circuit that guides the coolant, which has previously exchanged heat with the electric drive unit 23, to the battery 24. Furthermore, the eight-way valve 40 switches the coolant circulation passage 21 to form: the second circuit that guides the coolant, which has previously exchanged heat with the electric drive unit 23, to the chiller 16; and, simultaneously, the third circuit that returns the coolant, which has previously exchanged heat with the battery 24, to the battery 24 while bypassing the electric drive unit 23 and the chiller 16.

In this manner, by adopting the configuration in which the single eight-way valve 40 can switch the coolant circulation passage 21 among the first circuit, the second circuit and the third circuit, the number of the components of the temperature adjustment device 1 can be reduced compared to a configuration that includes a plurality of circuit switching devices for switching the coolant circulation passage 21. For this reason, the configuration of the coolant circulation passage 21, in which the coolant (the heat medium) circulates, can be simplified.

Furthermore, according to the embodiment described above, the following advantages can be obtained.

(1) In the embodiment described above, the eight-way valve 40 switches the coolant circulation passage 21 to form the fourth circuit that guides the coolant, which has previously exchanged heat with the electric drive unit 23 and the battery 24, to the chiller 16.

According to this configuration, the temperature adjustment device 1 can, by means of the single eight-way valve 40, switch the coolant circulation passage 21 to the fourth circuit in addition to the first circuit, the second circuit, and the third circuit. In this manner, by adopting the configuration in which the single eight-way valve 40 can switch the coolant circulation passage 21 among the first circuit, the second circuit, the third circuit and the fourth circuit, the number of the components of the temperature adjustment device 1 can be reduced compared to the configuration that includes the plurality of circuit switching devices for switching the coolant circulation passage 21.

(2) In the above embodiment, the first circuit is formed by the eight-way valve 40, the second pump 25b, the third pump 25c and the piping, which forms the coolant circulation passage 21.

According to this configuration, the configuration of the coolant circulation passage 21 can be simplified compared to the case where the first circuit includes components other than the eight-way valve 40, the second pump 25b, the third pump 25c and the piping, which forms the coolant circulation passage 21.

(3) In the above embodiment, the second circuit is formed by the eight-way valve 40, the first pump 25a, the third pump 25c and the piping, which forms the coolant circulation passage 21.

According to this configuration, the configuration of the coolant circulation passage 21 can be simplified compared to the case where the second circuit includes components other than the eight-way valve 40, the first pump 25a, the third pump 25c and the piping, which forms the coolant circulation passage 21.

(4) In the embodiment described above, the eight-way valve 40 forms the third circuit at the time of forming the second circuit.

According to this configuration, by using the single eight-way valve 40, it is possible to realize the second mode in which the coolant, which is heated by the heat of the electric drive unit 23, exchanges the heat with the refrigerant in the chiller 16, while simultaneously heating the battery 24 by using the heat generated by the battery 24 itself.

### Second Embodiment

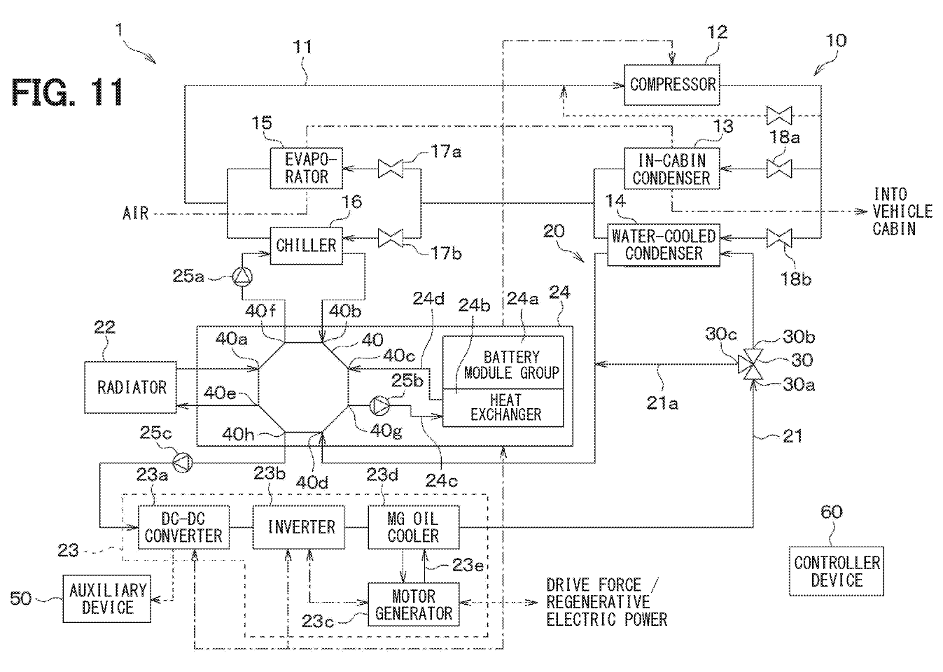

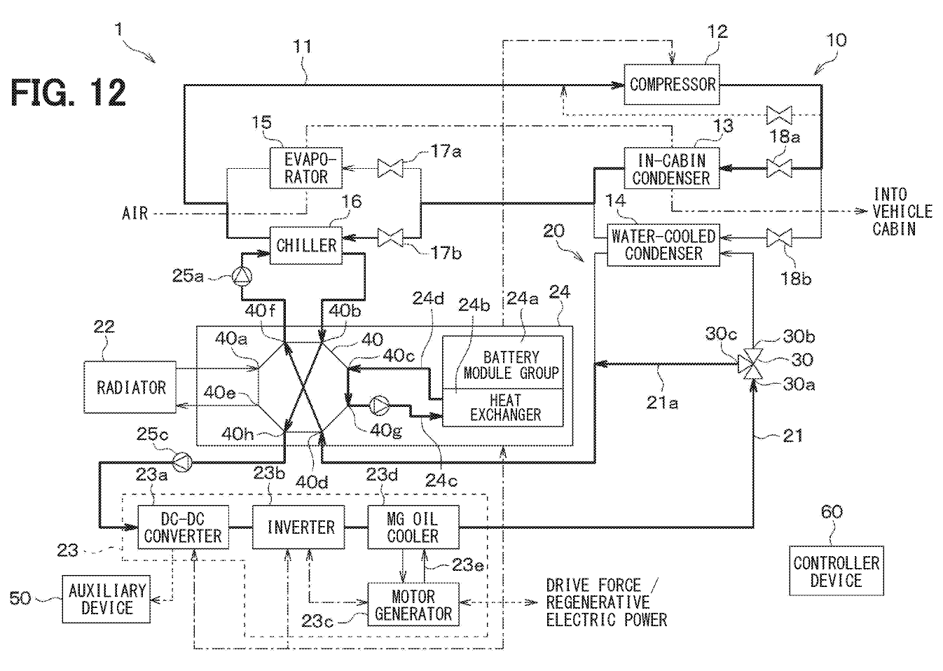

Next, the second embodiment will be described with reference to FIGS. 11 and 12. The present embodiment differs from the first embodiment in that the eight-way valve 40 and the second pump 25b are provided inside the battery 24. The rest of the present embodiment is the same as that of the first embodiment. Therefore, in the present embodiment, different portions, which are different from those of the first embodiment, will be mainly described, and the same portions, which are the same as those of the first embodiment, will not be described for the sake of simplicity.

As shown in FIG. 11, the eight-way valve 40 and the second pump 25b of the present embodiment are provided inside the battery 24. The battery 24 of the present embodiment includes: a battery module group 24a, which includes a plurality of battery cells; a heat exchanger 24b, through which the coolant for cooling the battery module group 24 flows; and a plurality of flow passages 24c, 24d that guide the coolant to and from the heat exchanger 24b.

The battery module group 24a is in contact with the heat exchanger 24b so that the battery module group 24a can exchange heat with the coolant that flows through the heat exchanger 24b. The heat exchanger 24b exchanges heat between the battery module group 24a and the coolant.

The flow passages 24c, 24d are provided between the eight-way valve 40 and the heat exchanger 24b. Specifically, the flow passages 24c, 24d include: a first flow passage 24c, which connects between an inlet of the heat exchanger 24b and the eight-way third outlet 40g; and a second flow passage 24d, which connects between an outlet of the heat exchanger 24b and the eight-way third inlet 40c.

The first flow passage 24c is a flow passage forming portion that guides the coolant, which flows out from the eight-way valve 40, to the heat exchanger 24b. The second flow passage 24d is a flow passage forming portion that guides the coolant, which flows out from the heat exchanger 24b, to the eight-way valve 40.

The second pump 25b is provided in the first flow passage 24c among the flow passages 24c, 24d in the battery 24. The flow passages 24c, 24d correspond to the coolant passages of the battery 24 in the first embodiment. Here, the second pump 25b may be provided in the second flow passage 24d.

In the temperature adjustment device 1 of the present embodiment with the above-described configuration, in the second mode, the eight-way valve 40 switches the coolant circulation passage 21 so as to form the third circuit that returns the coolant, which has previously exchanged heat with the battery 24, to the battery 24 while bypassing the electric drive unit 23 and the chiller 16. Furthermore, the third circuit of the present embodiment is formed inside the battery 24.

Further, when the temperature adjustment device 1 executes the second mode and thereby circulates the coolant in the fluid circuit system 20, the coolant circulates inside the battery 24 between the heat exchanger 24b and the eight-way valve 40, as shown in FIG. 12. That is, when the temperature adjustment device 1 of the present embodiment executes the second mode and heats the battery 24 by using the heat generated by the battery 24 itself to maintain the temperature of the battery 24 at a constant level, the coolant circulates inside the battery 24.

According to this configuration, when the second mode is executed to heat the battery 24 by using the heat generated by the battery 24 itself, the heat becomes less likely to be released from the coolant that has been heated by the heat generated by the battery 24, as compared with the case where the coolant is circulated via the outside of the battery 24. Therefore, the energy consumption, which results from the operation of the vehicle air-conditioning device at the time of executing the second mode, can be reduced.

### Third Embodiment

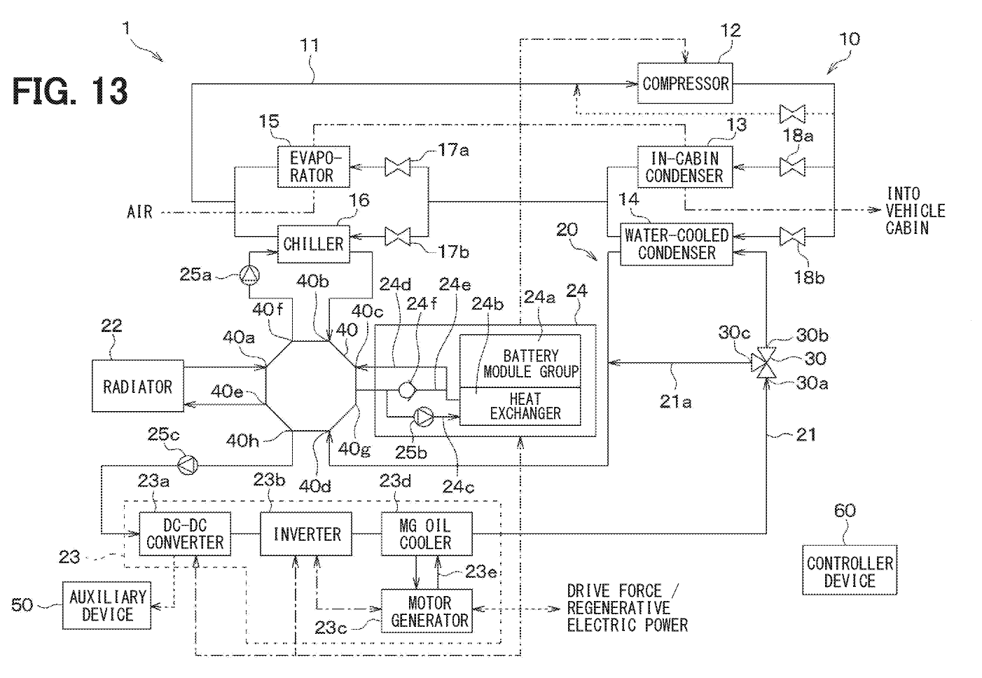

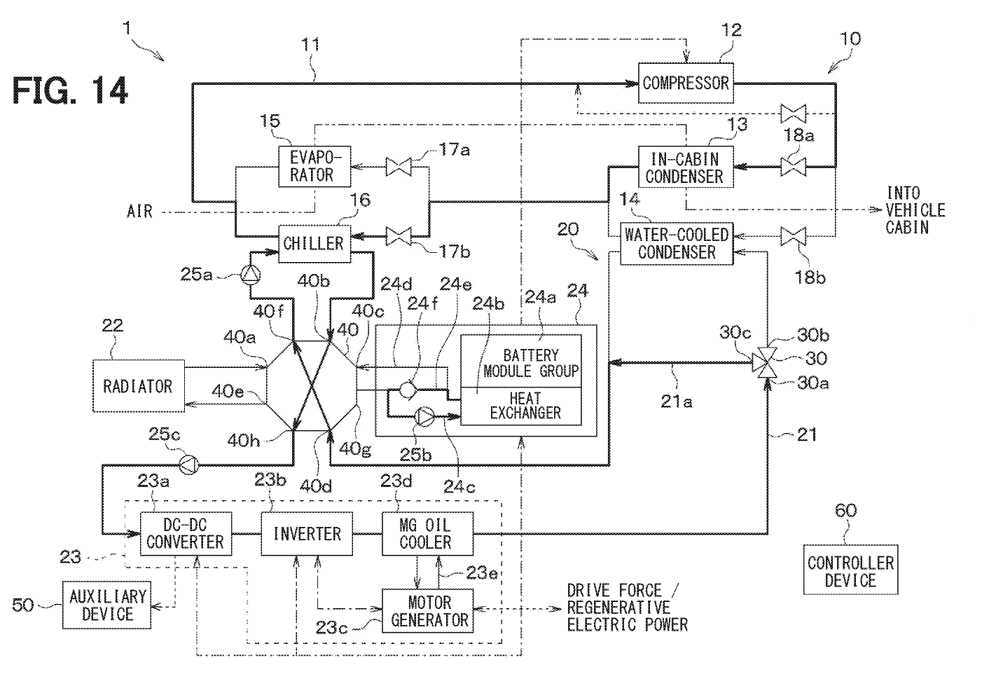

Next, the third embodiment will be described with reference to FIGS. 13 and 14. The present embodiment differs from the second embodiment in that the eight-way valve 40 is provided outside the battery 24 and in that the battery 24 has, inside thereof, a battery bypass passage 24e that bypasses the eight-way valve 40. The rest of the present embodiment is the same as that of the second embodiment. Therefore, in the present embodiment, different portions, which are different from those of the second embodiment, will be mainly described, and the same portions, which are the same as those of the second embodiment, will not be described for the sake of simplicity.

As shown in FIG. 13, the battery bypass passage 24e is provided between the first flow passage 24c and the second flow passage 24d. The battery bypass passage 24e is a flow passage forming portion that guides the coolant, which flows out from the heat exchanger 24b of the battery 24 and flows in the second flow passage 24d, to the first flow passage 24c, thereby bypassing the eight-way valve 40 and returning the coolant to the heat exchanger 24b again. One side of the battery bypass passage 24e is connected to a portion of the first flow passage 24c, which is disposed on an upstream side of the second pump 25b, and the other side of the battery bypass passage 24e is connected to the second flow passage 24d. A check valve 24f is provided in the battery bypass passage 24e.

The check valve 24f enables the fluid to flow from one side toward the other side of the check valve 24f and disables the fluid to flow from the other side toward the one side of the check valve 24f. The check valve 24f of the present embodiment enables the coolant to flow from the second flow passage 24d to the first flow passage 24c via the battery bypass passage 24e. In addition, the check valve 24f disables the coolant from flowing from the first flow passage 24c to the second flow passage 24d via the battery bypass passage 24e.

In the temperature adjustment device 1 of the present embodiment configured in this manner, in the second mode, the eight-way valve 40 prohibits inflow of the coolant from the eight-way third inlet 40c. Furthermore, the second flow passage 24d, the battery bypass passage 24e and the first flow passage 24c form the third circuit that returns the coolant, which has previously exchanged heat with the battery 24, to the battery 24 while bypassing the electric drive unit 23 and the chiller 16. Furthermore, the third circuit of the present embodiment is formed inside the battery 24.

Further, when the temperature adjustment device 1 executes the second mode and thereby circulates the coolant in the fluid circuit system 20, the coolant circulates inside the battery 24 without flowing to the eight-way valve 40 as shown in FIG. 14. Specifically, the coolant, which has flowed out from the heat exchanger 24b, flows in the order of the second flow passage 24d, the battery bypass passage 24e and the first flow passage 24c and returns to the heat exchanger 24b. Therefore, when the temperature adjustment device 1 of the present embodiment heats the battery 24 by using the heat generated by the battery 24 itself to maintain the temperature of the battery 24 at a constant level, the coolant circulates inside the battery 24.

According to this configuration, when the second mode is executed to heat the battery 24 by using the heat generated by the battery 24 itself, the heat becomes less likely to be released from the coolant that has been heated by the heat generated by the battery 24, as compared with the case where the coolant is circulated via the outside of the battery 24. Therefore, the energy consumption, which results from the operation of the vehicle air-conditioning device at the time of executing the second mode, can be reduced.

Furthermore, compared with the second embodiment, since there is no need to receive the eight-way valve 40 inside the battery 24, the housing of the battery 24 can be made smaller and the structure of the battery 24 can be simplified.

### Fourth Embodiment

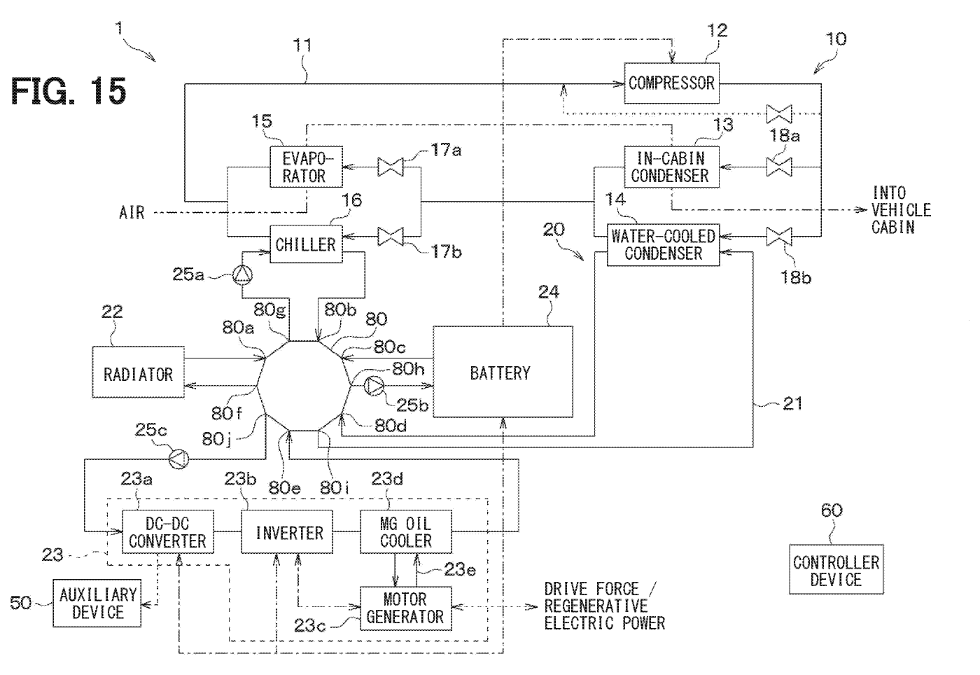

Next, the fourth embodiment will be described with reference to FIGS. 15 to 18. The present embodiment differs from the first embodiment in that the three-way valve 30 and the eight-way valve 40 are replaced by a ten-way valve 80 and, accordingly, a part of the coolant circulation passage 21 differs from the first embodiment. The rest of the present embodiment is the same as that of the first embodiment. Therefore, in the present embodiment, different portions, which are different from those of the first embodiment, will be mainly described, and the same portions, which are the same as those of the first embodiment, will not be described for the sake of simplicity.

In the present embodiment, the ten-way valve 80 for switching the coolant circulation passage 21 is provided in the coolant circulation passage 21, as shown in FIG. 15.

The ten-way valve 80 is a circuit switching device that has five flow inlets and five flow outlets and guides the coolant flowing in from one or more of the five flow inlets to corresponding one or more of the five flow outlets, which correspond to respective operating modes of the temperature adjustment device 1. The ten-way valve 80 has: a ten-way first inlet 80a connected to the outlet of the radiator 22; and a ten-way second inlet 80b connected to the outlet of the coolant passage of the chiller 16. Furthermore, the ten-way valve 80 has: a ten-way third inlet 80c connected to the outlet of the coolant passage of the battery 24; a ten-way fourth inlet 80d connected to the outlet of the coolant passage of the water-cooled condenser 14; and a ten-way fifth inlet 80e connected to the outlet of the coolant passage of the MG oil cooler 23d.

Furthermore, the ten-way valve 80 has: a ten-way first outlet 80f connected to the inlet of the radiator 22; and a ten-way second outlet 80g connected to the inlet of the coolant passage of the chiller 16. Furthermore, the ten-way valve 80 has: a ten-way third outlet 80h connected to the inlet of the coolant passage of the battery 24; a ten-way fourth outlet 80i connected to the inlet of the coolant passage of the water-cooled condenser 14; and a ten-way fifth outlet 80j connected to the inlet of the coolant passage of the DC-DC converter 23a.

The ten-way valve 80 is an electric valve device that includes: a valve element, a rotational position of which can be changed; and an electric actuator, which is configured to change an opening degree of the valve element. By adjusting the rotational position of the valve element, the ten-way valve 80 changes which outlets among the ten-way first outlet 80f, the ten-way second outlet 80g, the ten-way third outlet 80h, the ten-way fourth outlet 80i and the ten-way fifth outlet 80j communicate with corresponding inlets among the ten-way first inlet 80a, the ten-way second inlet 80b, the ten-way third inlet 80c, the ten-way fourth inlet 80d and the ten-way fifth inlet 80e.

For example, the ten-way valve 80 is configured such that, by adjusting the rotational position of the valve element, the ten-way first inlet 80a can be brought into communication with the ten-way second outlet 80g. Furthermore, the ten-way valve 80 is configured such that, by adjusting the rotational position of the valve element, the ten-way second inlet 80b can be brought into communication with one of the ten-way first outlet 80f, the ten-way third outlet 80h and the ten-way fifth outlet 80j. Furthermore, the ten-way valve 80 is configured such that, by adjusting the rotational position of the valve element, the ten-way third inlet 80c can be brought into communication with either the ten-way third outlet 80h or the ten-way fifth outlet 80j. Furthermore, the ten-way valve 80 is configured such that, by adjusting the rotational position of the valve element, the ten-way fifth inlet 80e can be brought into communication with either the ten-way second outlet 80g or the ten-way third outlet 80h. The ten-way valve 80 is electrically connected to the controller device 60, and the rotational position of the valve element is controlled by a control signal outputted from the controller device 60.

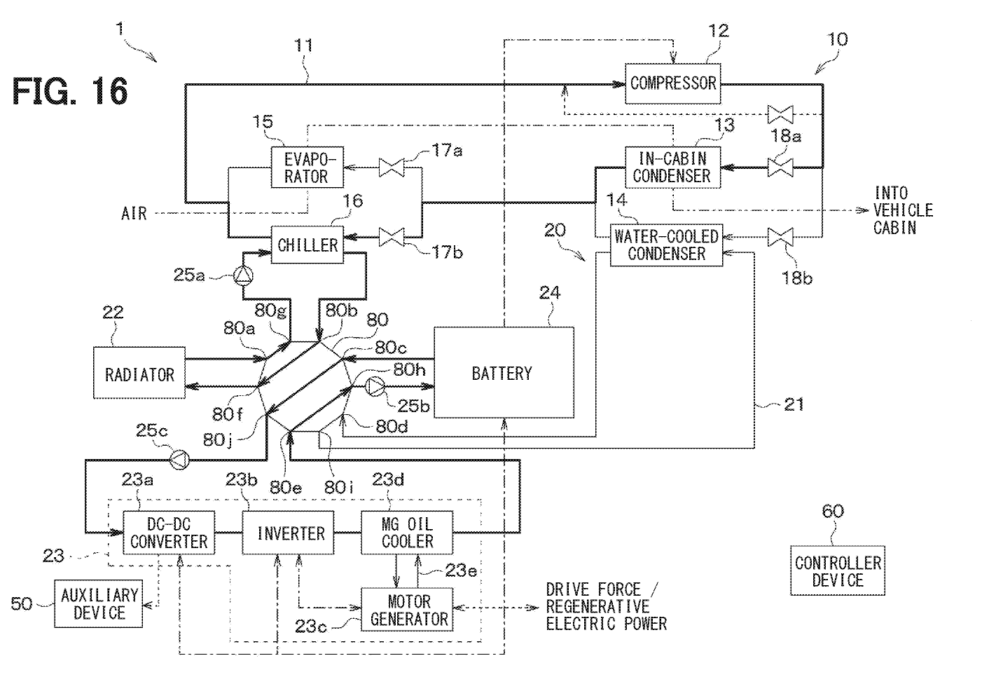

The operation of the ten-way valve 80 and the flow of the coolant in the fluid circuit system 20 when the temperature adjustment device 1 of the present embodiment configured in the above-described manner executes each of the operating modes will be described below with reference to FIGS. 16 to 18. Note that the flow of the refrigerant through the refrigeration cycle 10 at the time of executing each of the operating modes by the temperature adjustment device 1 is the same as in the first embodiment, and therefore the description thereof is omitted.

When the controller device 60 executes the first mode, the controller device 60 communicates the ten-way first inlet 80a with the ten-way second outlet 80g in the ten-way valve 80 and communicates the ten-way second inlet 80b with the ten-way first outlet 80f in the ten-way valve 80. Furthermore, the controller device 60 communicates the ten-way third inlet 80c with the ten-way fifth outlet 80j in the ten-way valve 80 and communicates the ten-way fifth inlet 80e with the ten-way third outlet 80h in the ten-way valve 80.

As a result, as shown in FIG. 16, in the fluid circuit system 20, the coolant flows in the order of the first pump 25a, the coolant passage of the chiller 16, the ten-way valve 80 and the radiator 22 and circulates between the chiller 16 and the radiator 22. Furthermore, in the fluid circuit system 20, the coolant flows in the order of the third pump 25c, the coolant passage of the DC-DC converter 23a, the coolant passage of the inverter 23b, the coolant passage of the MG oil cooler 23d, the ten-way valve 80, the second pump 25b, the coolant passage of the battery 24 and the ten-way valve 80. That is, the coolant circulates among the DC-DC converter 23a, the inverter 23b, the MG oil cooler 23d and the battery 24.

As shown in FIG. 16, in the first mode in which the refrigerant and the coolant circulate in this manner, the coolant absorbs heat from the outside air in the radiator 22 and is thereby heated. Furthermore, the vehicle air-conditioning device heats the vehicle cabin by using the heat from the outside air.

Furthermore, in the first mode, the temperature adjustment device 1 recovers the waste heat that is generated by the operation of the DC-DC converter 23a, the inverter 23b and the motor generator 23c and uses this otherwise unnecessary heat to heat the battery 24, and additionally heats the battery 24 by the heat generated by the battery 24 itself.

When the controller device 60 executes the second mode, the controller device 60 communicates the ten-way second inlet 80b with the ten-way fifth outlet 80j in the ten-way valve 80 and communicates the ten-way third inlet 80c with the ten-way third outlet 80h in the ten-way valve 80. Furthermore, the controller device 60 communicates the ten-way fifth inlet 80e with the ten-way second outlet 80g in the ten-way valve 80.

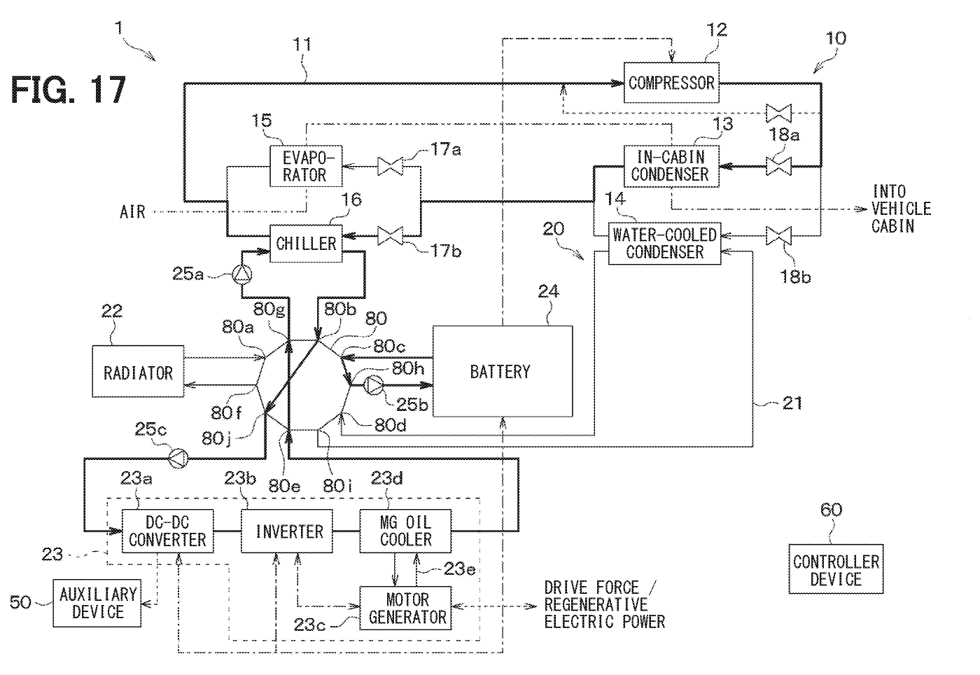

Thereby, as shown in FIG. 17, in the fluid circuit system 20, the coolant flows in the order of the first pump 25a, the coolant passage of the chiller 16, the ten-way valve 80, the third pump 25c, the coolant passage of the DC-DC converter 23a, the coolant passage of the inverter 23b, the coolant passage of the MG oil cooler 23d and the ten-way valve 80. That is, the coolant circulates among the chiller 16, the DC-DC converter 23a, the inverter 23b and the MG oil cooler 23d. Furthermore, in the second mode, in the fluid circuit system 20, the coolant flows in the order of the second pump 25b, the coolant passage of the battery 24 and the ten-way valve 80. That is, the coolant circulates between the battery 24 and the ten-way valve 80.

In the second mode during which the refrigerant and the coolant circulate as shown in FIG. 17, the coolant, which passes through the DC-DC converter 23a, the inverter 23b and the motor generator 23c, is heated by the heat generated by the operation of these heat-generating devices. Then, the vehicle air-conditioning device heats the vehicle cabin using the waste heat from the DC-DC converter 23a, the inverter 23b and the motor generator 23c.

Furthermore, in the second mode, the temperature adjustment device 1 heats the battery 24 by the heat generated by the battery 24 itself so that the temperature of the battery 24 is maintained at a constant level.

When the controller device 60 executes the third mode, the controller device 60 communicates the ten-way second inlet 80b with the ten-way third outlet 80h in the ten-way valve 80 and communicates the ten-way third inlet 80c with the ten-way fifth outlet 80j in the ten-way valve 80. Furthermore, the controller device 60 communicates the ten-way fifth inlet 80e with the ten-way second outlet 80g in the ten-way valve 80.

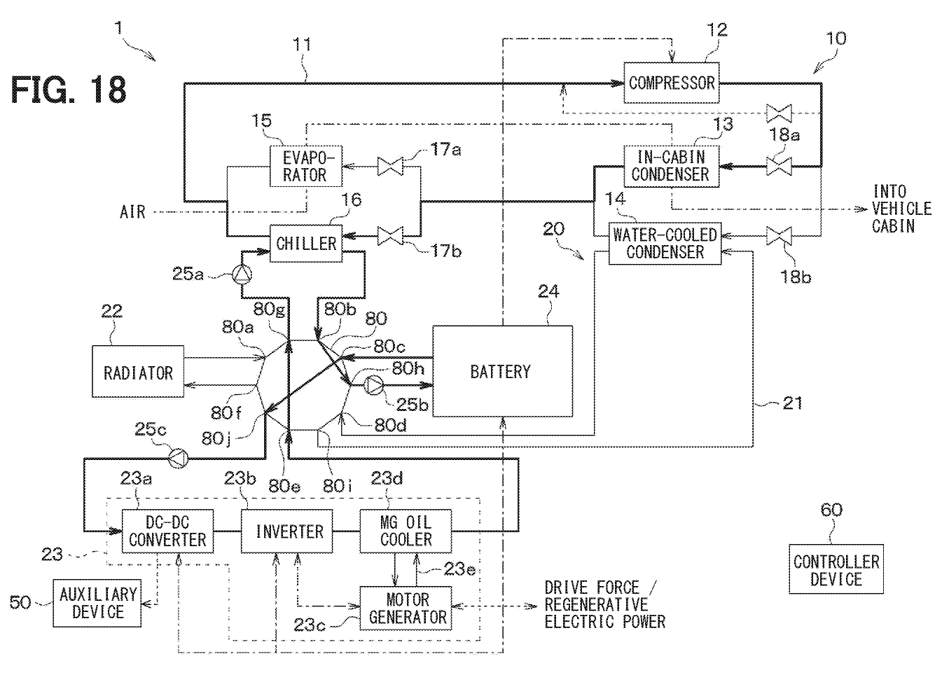

Thereby, as shown in FIG. 18, in the fluid circuit system 20, the coolant flows in the order of the first pump 25a, the coolant passage of the chiller 16, the ten-way valve 80, the second pump 25b, the coolant passage of the battery 24, the ten-way valve 80, the third pump 25c, the coolant passage of the DC-DC converter 23a, the coolant passage of the inverter 23b, the coolant passage of the MG oil cooler 23d and the ten-way valve 80. That is, the coolant circulates among the chiller 16, the battery 24, the DC-DC converter 23a, the inverter 23b and the MG oil cooler 23d.

In the third mode during which the refrigerant and the coolant circulate as shown in FIG. 18, the coolant, which passes through the DC-DC converter 23a, the inverter 23b, the motor generator 23c and the battery 24, is heated by the heat generated by the operation of these heat-generating devices. Then, the vehicle air-conditioning device heats the vehicle cabin using the waste heat from the DC-DC converter 23a, the inverter 23b, the motor generator 23c and the battery 24.

As described above, in the temperature adjustment device 1 of the present embodiment, the ten-way valve 80 switches the coolant circulation passage 21 to form the first circuit that guides the coolant, which has previously exchanged heat with the electric drive unit 23, to the battery 24. Furthermore, the ten-way valve 80 switches the coolant circulation passage 21 to form: the second circuit that guides the coolant, which has previously exchanged heat with the electric drive unit 23, to the chiller 16; and, simultaneously, the third circuit that returns the coolant, which has previously exchanged heat with the battery 24, to the battery 24 while bypassing the electric drive unit 23 and the chiller 16.

In this manner, by adopting the configuration in which the single ten-way valve 80 can switch the coolant circulation passage 21 among the first circuit, the second circuit and the third circuit, the number of the components of the temperature adjustment device 1 can be reduced compared to the configuration that includes the plurality of circuit switching devices for switching the coolant circulation passage 21. For this reason, the configuration of the coolant circulation passage 21, in which the coolant (the heat medium) circulates, can be simplified.

### Other Embodiments

Although the representative embodiments of the present disclosure have been described above, the present disclosure is not limited to the above-described embodiments and can be variously modified, for example, as follows.

In the embodiments described above, the example has been described in which the temperature adjustment device 1 is applied to the electric vehicle that includes the vehicle air-conditioning device which includes the rechargeable/dischargeable battery 24 and the refrigeration cycle 10. However, the present disclosure is not limited to this configuration.

For example, the temperature adjustment device 1 may be applied to a hybrid vehicle that includes the vehicle air-conditioning device which includes the rechargeable/dischargeable battery 24 and the refrigeration cycle 10. Furthermore, the temperature adjustment device 1 may be applied to a vehicle other than the automobile as long as the vehicle is equipped with the vehicle air-conditioning device which includes the rechargeable/dischargeable battery 24 and the refrigeration cycle 10.

In the embodiments described above, the example has been described in which the eight-way valve 40 or the ten-way valve 80 switches the coolant circulation passage 21 to form the fourth circuit that guides the coolant, which has previously exchanged heat with the electric drive unit 23 and the battery 24, to the chiller 16. However, the present disclosure is not limited to this configuration.

For example, each of the eight-way valve 40 and the ten-way valve 80 may be configured so as not to form the fourth circuit. In this case, the temperature adjustment device 1 may further include, in addition to the eight-way valve 40 or the ten-way valve 80, a valve that switches the coolant circulation passage 21 and may be configured such that this valve can switch the coolant circulation passage 21 to the fourth circuit.

In the embodiments described above, the example has been described in which the first circuit is formed by the eight-way valve 40, the second pump 25b, the third pump 25c and the piping, which forms the coolant circulation passage 21. However, the present disclosure is not limited to this configuration.

For example, the first circuit may further include one or more other components in addition to the eight-way valve 40, the second pump 25b, the third pump 25c and the piping, which forms the coolant circulation passage 21.

In the embodiments described above, the example has been described in which the second circuit is formed by the eight-way valve 40, the first pump 25a, the third pump 25c and the piping, which forms the coolant circulation passage 21. However, the present disclosure is not limited to this configuration.

For example, the second circuit may further include one or more other components in addition to the eight-way valve 40, the first pump 25a, the third pump 25c and the piping, which forms the coolant circulation passage 21.

Needless to say, in the above-described embodiments, the components of the embodiment(s) are not necessarily essential except when it is clearly indicated that they are essential and when they are clearly considered to be essential in principle.

In the above-described embodiments, when the numerical values, such as the number, numerical value, quantity, range, etc. of the components of the embodiment(s) are mentioned, the numerical values are not limited to those described in the embodiment(s) except when it is clearly indicated that the numeric values are essential and when the numeric values are clearly considered to be essential in principle.

In the above-described embodiments, when a shape, a positional relationship, etc. of the component(s) is mentioned, the shape, positional relationship, etc. are not limited to those described in the embodiment(s) unless otherwise specified or limited in principle to those described in the embodiment(s).

The controller device 60 and its method of the present disclosure may be realized by a dedicated computer that is provided by configuring a processor and a memory programmed to perform one or more functions embodied by a computer program. The controller device 60 and its method of the present disclosure may be realized by a dedicated computer that is provided by configuring a processor with one or more dedicated hardware logic circuits. The controller device 60 and its method of the present disclosure may be realized by one or more dedicated computers that are formed by a combination of (A) a processor and a memory programmed to perform one or more functions and (B) a processor formed by one or more hardware logic circuits. Further, the computer program may also be stored in a computer-readable, non-transitory, tangible storage medium as instructions to be executed by a computer.

### Aspects of Present Disclosure

The present disclosure described above can be understood as the following aspects, for example.

### Aspect 1

According to aspect 1, there is provided a temperature adjustment device to be applied to a vehicle that includes an electric drive unit, which is configured to output drive force for driving the vehicle, a battery, which is configured to supply electric power to the electric drive unit, and a vehicle air-conditioning device, which includes a refrigeration cycle that is configured to circulate a refrigerant, the temperature adjustment device comprising: a heat medium circuit that is configured to circulate a heat medium for exchanging heat with at least one of the electric drive unit and the battery; a heat exchange unit that is provided in the heat medium circuit and is configured to exchange heat between the heat medium, which has previously exchanged heat with at least one of the electric drive unit and the battery, and the refrigerant; and a single circuit switching device that is connected to the electric drive unit, the battery and the heat exchange unit and is provided in the heat medium circuit, wherein the single circuit switching device is configured to switch the heat medium circuit so as to selectively form at least one of: a first circuit that is configured to guide the heat medium, which has previously exchanged heat with the electric drive unit, to the battery; a second circuit that is configured to guide the heat medium, which has previously exchanged heat with the electric drive unit, to the heat exchange unit; and a third circuit that is configured to return the heat medium, which has previously exchanged heat with the battery, to the battery while the third circuit bypasses the electric drive unit and the heat exchange unit.

### Aspect 2

According to aspect 2, there is provided the temperature adjustment device according to aspect 1, wherein the single circuit switching device is configured to switch the heat medium circuit so as to selectively form a fourth circuit that is configured to guide the heat medium, which has previously exchanged heat with the electric drive unit and the battery, to the heat exchange unit.

### Aspect 3

According to aspect 3, there is provided the temperature adjustment device according to aspect 1 or 2, comprising a pumping unit that is configured to pump the heat medium in the heat medium circuit, wherein the single circuit switching device, the pumping unit, and piping, which forms the heat medium, form the first circuit.

### Aspect 4

According to aspect 4, there is provided the temperature adjustment device according to any one of aspects 1 to 3, comprising a pumping unit that is configured to pump the heat medium in the heat medium circuit, wherein the single circuit switching device, the pumping unit, and piping, which form the heat medium, form the second circuit.

### Aspect 5

According to aspect 5, there is provided the temperature adjustment device according to any one of aspects 1 to 4, wherein the third circuit is formed inside the battery.

### Aspect 6

According to aspect 6, there is provided the temperature adjustment device according to aspect 5, wherein: the single circuit switching device is provided inside the battery; and the battery includes: a battery module group that includes a plurality of battery cells; a heat exchanger that is configured to exchange heat between the battery module group and the heat medium; a first flow passage that is configured to guide the heat medium, which flows out from the single circuit switching device, to the heat exchanger; and a second flow passage that is configured to guide the heat medium, which flows out from the heat exchanger, to the single circuit switching device.

### Aspect 7

According to aspect 7, there is provided the temperature adjustment device according to aspect 5, wherein the battery includes: a battery module group which includes a plurality of battery cells; a heat exchanger that is configured to exchange heat between the battery module group and the heat medium; a first flow passage that is configured to guide the heat medium, which flows out from the single circuit switching device, to the heat exchanger; a second flow passage that is configured to guide the heat medium, which flows out from the heat exchanger, to the single circuit switching device; a battery bypass passage that is configured to guide the heat medium, which flows in the second flow passage, to the first flow passage while the battery bypass passage bypasses the single circuit switching device; and a check valve that is provided in the battery bypass passage, wherein the check valve is configured to enable the heat medium to flow from the second flow passage to the first flow passage via the battery bypass passage and disable the heat medium from flowing from the first flow passage to the second flow passage via the battery bypass passage.

### Aspect 8

According to aspect 8, there is provided the temperature adjustment device according to any one of aspects 1 to 7, wherein the single circuit switching device is configured to form the third circuit when the single circuit switching device forms the second circuit.

What is claimed is:

1. A temperature adjustment device to be applied to a vehicle that includes an electric drive unit, which is configured to output drive force for driving the vehicle, a battery, which is configured to supply electric power to the electric drive unit, and a vehicle air-conditioning device, which includes a refrigeration cycle that is configured to circulate a refrigerant, the temperature adjustment device comprising:
a heat medium circuit that is configured to circulate a heat medium for exchanging heat with at least one of the electric drive unit and the battery;
a heat exchange unit that is provided in the heat medium circuit and is configured to exchange heat between the heat medium, which has previously exchanged heat with at least one of the electric drive unit and the battery, and the refrigerant; and
a single circuit switching device that is connected to the electric drive unit, the battery and the heat exchange unit and is provided in the heat medium circuit, wherein the single circuit switching device is configured to switch the heat medium circuit so as to selectively form at least one of:
a first circuit that is configured to guide the heat medium, which has previously exchanged heat with the electric drive unit, to the battery;
a second circuit that is configured to guide the heat medium, which has previously exchanged heat with the electric drive unit, to the heat exchange unit;
a third circuit that is configured to return the heat medium, which has previously exchanged heat with the battery, to the battery while the third circuit bypasses the electric drive unit and the heat exchange unit; and
a fourth circuit that is configured to guide the heat medium, which has previously exchanged heat with the electric drive unit and the battery, to the heat exchange unit, wherein:
when a battery temperature, which is a temperature of the battery, is lower than a first determination temperature, equal to or above which an output necessary for driving the electric drive unit is obtainable from the battery, the heat medium circuit is switched so as to form the first circuit;
when the battery temperature is equal to or higher than the first determination temperature and is lower than a second determination temperature, which is higher than the first determination temperature and at which the output necessary for driving the electric drive unit is obtainable from the battery even when own heat generation of the battery is utilized to heat the vehicle cabin, the heat medium circuit is switched so as to form both the second circuit and the third circuit, and
when the battery temperature is equal to or higher than the second determination temperature, the heat medium circuit is switched so as to form the fourth circuit.

2. The temperature adjustment device according to claim 1, wherein the third circuit is formed inside the battery.

3. The temperature adjustment device according to claim 2, wherein:
the single circuit switching device is provided inside the battery; and
the battery includes:
a battery module group that includes a plurality of battery cells;
a heat exchanger that is configured to exchange heat between the battery module group and the heat medium;
a first flow passage that is configured to guide the heat medium, which flows out from the single circuit switching device, to the heat exchanger; and
a second flow passage that is configured to guide the heat medium, which flows out from the heat exchanger, to the single circuit switching device.

4. The temperature adjustment device according to claim 2, wherein the battery includes:
a battery module group which includes a plurality of battery cells;
a heat exchanger that is configured to exchange heat between the battery module group and the heat medium;
a first flow passage that is configured to guide the heat medium, which flows out from the single circuit switching device, to the heat exchanger;
a second flow passage that is configured to guide the heat medium, which flows out from the heat exchanger, to the single circuit switching device;
a battery bypass passage that is configured to guide the heat medium, which flows in the second flow passage, to the first flow passage while the battery bypass passage bypasses the single circuit switching device; and
a check valve that is provided in the battery bypass passage, wherein the check valve is configured to enable the heat medium to flow from the second flow passage to the first flow passage via the battery bypass passage and disable the heat medium from flowing from the first flow passage to the second flow passage via the battery bypass passage.

5. The temperature adjustment device according to claim 1, comprising a pumping unit that is configured to pump the heat medium in the heat medium circuit, wherein the single circuit switching device, the pumping unit, and piping, which forms the heat medium circuit, form the first circuit.

6. The temperature adjustment device according to claim 1, comprising a pumping unit that is configured to pump the heat medium in the heat medium circuit, wherein the single circuit switching device, the pumping unit, and piping, which form the heat medium circuit, form the second circuit.

7. The temperature adjustment device according to claim 1, wherein the single circuit switching device is configured to form the third circuit when the single circuit switching device forms the second circuit.

8. A temperature adjustment device to be applied to a vehicle that includes an electric drive unit, which is configured to output drive force for driving the vehicle, a battery, which is configured to supply electric power to the electric drive unit, and a vehicle air-conditioning device, which includes a refrigeration cycle that is configured to circulate a refrigerant, the temperature adjustment device comprising:
a heat medium circuit that is configured to circulate a heat medium for exchanging heat with at least one of the electric drive unit and the battery;
a heat exchange unit that is provided in the heat medium circuit and is configured to exchange heat between the heat medium, which has previously exchanged heat with the at least one of the electric drive unit and the battery, and the refrigerant; and
a single circuit switching device that is connected to the electric drive unit, the battery and the heat exchange unit and is provided in the heat medium circuit, wherein the single circuit switching device is configured to switch the heat medium circuit so as to selectively form at least one of:
a first circuit that is configured to guide the heat medium, which has previously exchanged heat with the electric drive unit, to the battery;
a second circuit that is configured to guide the heat medium, which has previously exchanged heat with the electric drive unit, to the heat exchange unit; and
a third circuit that is configured to return the heat medium, which has previously exchanged heat with the battery, to the battery while the third circuit bypasses the electric drive unit and the heat exchange unit, wherein:
the third circuit is formed inside the battery; and
the battery includes:
a battery module group which includes a plurality of battery cells;
a heat exchanger that is configured to exchange heat between the battery module group and the heat medium;
a first flow passage that is configured to guide the heat medium, which flows out from the single circuit switching device, to the heat exchanger;
a second flow passage that is configured to guide the heat medium, which flows out from the heat exchanger, to the single circuit switching device;
a battery bypass passage that is configured to guide the heat medium, which flows in the second flow passage, to the first flow passage while the battery bypass passage bypasses the single circuit switching device; and
a check valve that is provided in the battery bypass passage, wherein the check valve is configured to enable the heat medium to flow from the second flow passage to the first flow passage via the battery bypass passage and disable the heat medium from flowing from the first flow passage to the second flow passage via the battery bypass passage.

9. The temperature adjustment device according to claim 8, wherein the single circuit switching device is configured to switch the heat medium circuit so as to selectively form a fourth circuit that is configured to guide the heat medium, which has previously exchanged heat with the electric drive unit and the battery, to the heat exchange unit.

10. The temperature adjustment device according to claim 8, comprising a pumping unit that is configured to pump the heat medium in the heat medium circuit, wherein the single circuit switching device, the pumping unit, and piping, which forms the heat medium circuit, form the first circuit.

11. The temperature adjustment device according to claim 8, comprising a pumping unit that is configured to pump the heat medium in the heat medium circuit, wherein the single circuit switching device, the pumping unit, and piping, which form the heat medium circuit, form the second circuit.

12. The temperature adjustment device according to claim 8, wherein the single circuit switching device is configured to form the third circuit when the single circuit switching device forms the second circuit.
